(19) United States
(12) Patent Application Publication
(10) Pub. No.: US 2013/0132148 A1
(43) Pub. Date: May 23, 2013

(54) METHOD FOR MULTI-OBJECTIVE QUALITY-DRIVEN SERVICE SELECTION

(71) Applicant: Ecole Polytechnique Federale De Lausanne (EPF, Lausanne (CH)

(72) Inventors: Immanuel TRUMMER, Lausanne (CH); Boi FALTINGS, Preverenges (CH)

(73) Assignee: ECOLE POLYTECHNIQUE FEDERALE DE LAUSANNE (EPFL), Lausanne (CH)

(21) Appl. No.: 13/670,864

(22) Filed: Nov. 7, 2012

Related U.S. Application Data
(60) Provisional application No. 61/556,338, filed on Nov. 7, 2011.

(51) Int. Cl. G06Q 10/06

(52) U.S. Cl. CPC G06Q 10/0633
USPC 705/7.27

(57) ABSTRACT

This invention relates to the field of multi-objective workflow optimization. Certain exemplary embodiments of the invention are applicable in cases where workflow descriptions contain choice variables relating for instance to the selection of a specific service provider out of several service providers that provide similar services, to the selection of human workers, or to the selection between alternative subworkflows. A binding represents a combination of choices, binding the choice variables to specific values. Bindings induce specific cost and/or quality properties to the workflow, a binding being Pareto-optimal if no other binding exists that is at least as good for every cost and/or quality property and better for at least one property. Certain exemplary embodiments relate to a system and/or computer-implemented method for computing an approximation of the set of Pareto-optimal bindings such that the computed approximation satisfies specified minimum precision requirements

### CROSS-REFERENCE TO RELATED APPLICATION

The present application claims the benefit of the priority of U.S. patent application No. 61/556,338, filed on Nov. 7, 2011 in the name of Immanuel Trummer and Boi Faltings, the entire disclosure of which is incorporated herein by reference.

### TECHNICAL FIELD

Certain exemplary embodiments of this invention relate to the field of multi-objective workflow optimization. Certain exemplary embodiments of the invention are applicable in cases where workflow descriptions contain choice variables relating for instance to the selection of a specific service provider out of several service providers that provide similar services, to the selection of human workers, or to the selection between alternative subworkflows. A binding represents a combination of choices, binding the choice variables to specific values. Bindings induce specific cost and/or quality properties to the workflow, a binding being Pareto-optimal if no other binding exists that is at least as good for every cost and/or quality property and better for at least one property. Certain exemplary embodiments relate to a system and/or computer-implemented method for computing an approximation of the set of Pareto-optimal bindings such that the computed approximation satisfies specified minimum precision requirements.

### BACKGROUND AND SUMMARY

### 1. Introduction

Software products nowadays need to continuously evolve within an open environment, see reference [1]. Software has therefore moved from monolithic, static, and centralized structures to modular, dynamic, and distributed ones. This shift has been supported by the development of new architectural paradigms. Service-Oriented Architectures, see reference [2], (SOAs) are currently one of the most successful ones among them. They center around the abstraction of a service that encapsulates atomic functionality. Services can be composed into SOA applications, using orchestration languages such as the Business Process Execution Language (BPEL), see reference [3].

The services within an SOA application are loosely coupled. Therefore, one service can easily be replaced by another service that is functionally equivalent. This possibility is interesting, because functionally equivalent services may differ in their non-functional Quality-of-Service (QoS) properties such as invocation cost, response time, and quality of result. The QoS of the SOA application are determined by the QoS properties of the selected services. So by exchanging the used services, one can implicitly tune the QoS of the SOA application.

Business processes are often composed of services that are provided by outside service providers.

For example, construction projects are rarely executed by a single contractor, but outsourced to subcontractors.

Software is composed by composing different services, some of which may be in-house and some of which may be outsourced to other providers. An investment portfolio may be composed of different funds that are obtained from different providers. One will refer to all such scenarios as composing workflows from services, or service composition, and business processes that use outside services are said to follow a service-oriented architecture.

A common problem in service composition scenarios is how to select the services that are actually used. There is often considerable choice: there may be many construction companies able to carry out a particular task, there are many different software methods that can be used for the same task, and they may be available from different providers, and there are many different investment funds and fund providers. The criterion for choosing services may be, for example, the quality of the overall workflow, which is a function of the qualities of the individual services and the way that they are composed. Examples of quality criteria could be the time to complete a task, the cost of the service, the reliability, or the risk associated with an investment service. A problem associated with quality-driven service selection is how to select individual services in a way that the overall quality of the composed workflow is optimized.

In addition to the choice between different services, workflow descriptions can be associated with other choice variables. For instance, one part of the workflow can be realized by different sub-workflows. The selection of the used sub-workflow results again in different cost and/or quality properties for the entire workflow. This invention in certain exemplary embodiments relates to a system and/or computer-implemented method that is applicable in cases mentioned above and easily generalizes to further application scenarios where workflows description comprise choice variables such that the associated choices result the cost and/or quality properties of the entire workflow.

One refers to an assignment from every choice variable to one specific value (representing a specific choice) by the term binding. Bindings induce specific cost and/or quality properties for the workflow they refer to. A binding is dominated if another binding exists that is not worse for any cost and/or quality property and better for at least one cost and/or quality property. A binding which is not dominated is also called Pareto-optimal. When selecting a binding, it generally is not interesting to select dominated (e.g. not Pareto-optimal) bindings since another binding exists which is overall preferable. The choice between bindings in some instances can therefore be restricted to the choice between Pareto-optimal bindings.

The selection of an optimal binding out of all possible bindings can be done in a two-step approach. In the first step, the set of all Pareto-optimal bindings is calculated. In the second step, a specific binding is selected. This has several advantages comparing with an approach where an optimal binding is selected without computing the set of Pareto-optimal bindings as an intermediary step (one refers to the latter alternative in the following as direct selection):
When selecting a binding directly, this requires users to specify a utility function in advance that weights between different, possibly conflicting, cost and/or quality properties and defines the best compromise between them. However, for users it can be difficult to capture their real preferences in a utility function, see references [4, 5]. It is more natural to present to them information about the range of possible tradeoffs between different cost and/or quality properties and let them select a binding based on that information. Having calculated the set of Pareto-optimal solutions in an intermediary step, one can easily provide users with that information.
Different users might be interested in executing the same workflow and have the same choices regarding that workflow. Since different users have different preferences and priorities concerning cost and/or quality properties, the same binding will not represent the optimal tradeoff between different cost and/or quality properties for all possible users. While the optimal binding is not the same for all users, all users would want to select one out of the Pareto-optimal bindings. Once the set of Pareto-optimal bindings is calculated, it can therefore be reused for an efficient selection of the optimal binding for several users. Calculating the set of Pareto-optimal bindings once and efficiently selecting one of them for every user can be more efficient than calculating the optimal bindings separately for every user.
Approaches that select the optimal binding directly are often based on methods that impose restrictions on the allowed cost and/or quality properties or the utility function that specifies the best compromise between different cost and/or quality properties. Examples for such restricted approaches include the use of integer linear programming for quality-driven service selection [9, 10 and 14]. If a specific scenario motivates cost and/or quality properties and a utility function for which no direct selection method is applicable, an approach for calculating Pareto-optimal bindings and selecting between those in a second step can be the only possibility.

The problem of finding Pareto-optimal bindings has been motivated and one will now discuss prior art in this field and point out weaknesses that this invention in certain exemplary embodiments overcomes. A first branch of prior art consists of computer-implemented methods that aim at systematically enumerating all Pareto-optimal bindings. One calls those the exact methods, since they provide formal guarantees that all Pareto-optimal bindings are found. While delivering perfect precision, efficiency can easily become a problem with this type of method. While the set of Pareto-optimal binding is supposed to be small in comparison to the total set of possible bindings, this is not always the case. And even if the set of Pareto-optimal bindings is several orders of magnitude smaller than the set of possible bindings, it still might be too large to be fully generated for workflows of realistic size. In the worst case, the number of Pareto-optimal bindings grows exponentially in the number of choice variables and so does the minimum number of steps required by any exact method (one will provide a formal proof for this statement during the description of a specific embodiment of our invention). Therefore, while exact methods guarantee precision they do not guarantee efficiency.

A second branch of prior art consists of methods called heuristic methods that do not guarantee to find all Pareto-optimal bindings and may even return bindings whose cost and/or quality properties are arbitrarily far (referring to a suitable metric comparing cost and/or quality properties) from the ones of Pareto-optimal bindings. The reason is that those methods rely on randomization or on rules of thumb to generate Pareto-optimal bindings. Such methods can guarantee efficiency by restricting for instance the number of iterations of an iterative, randomized computer-implemented method. However, they do not provide formal guarantees on how closely the computed bindings approximate the real set of Pareto-optimal bindings (referring to a suitable metric for comparing a set of bindings with the set of Pareto-optimal bindings).

In the present application, a system and/or computer-implemented method is described that does not belong to either of those two branches. Instead, certain exemplary embodiments aim at the sweet spot between the two extremes, combining good precision with good efficiency. Having outlined the two major branches of prior art, one will provide references to and details about related work that realizes one of those approaches. The references below relate to the application area of Quality-Driven Service Selection (QDSS), meaning that choice variables associated with the workflow description relate to the choice between different service providers, as most prior art has been developed for this area. More specifically, one uses in the following the term Pareto Quality-Driven Service selection (PQDSS) to refer to the problem of computing the set of Pareto-optimal bindings or an approximation thereof.

Different heuristic methods have been proposed for PQDSS. Claro et al., see reference [8], use a specific genetic algorithm (GA) for multi-criteria optimization and apply it to PQDSS. This GA in is compared with in the experimental evaluation. Wada et al., see reference [27], use a GA as well. Jiuxin et al., see reference [28], use particle swarm optimization for PQDSS. They claim lower time complexity than the GA but point out that solution quality may fluctuate due to the randomness of the approach. Kousalya et al., see reference [29] propose to use multi-objective bees algorithms for PQDSS. Those are population-based, heuristic search algorithms that mimic the behavior of honey bees. Common to all those methods is that they run in polynomial time but cannot guarantee approximation quality.

Exact methods aim at calculating the explicit, real Pareto frontier in PQDSS. Since the size of the Pareto frontier may grow exponentially in the number of workflow tasks, such algorithms typically cannot have polynomial time complexity. Yu and Bouguettaya, see references [7, 30], present algorithms for calculating all Pareto-optimal bindings (the service skyline in their terminology) in a bottom-up fashion. The One-Pass algorithm (OPA) enumerates bindings and prunes dominated ones, optimizing the order of enumeration to prune as early as possible. The Dual Progressive Algorithm (DPA) progressively reports Pareto-optimal bindings, so partial results can already be retrieved before the algorithm terminates. The Bottom-Up Algorithm (BUA) improves the efficiency of DPA by calculating the Pareto set for larger and larger parts of the workflow. In additional work, see reference [31], Yu and Bouguettaya generalize the PQDSS problem to cover uncertainty with respect to provider QoS. As outlined before, this type of method cannot guarantee efficiency.

Within the description below, one will focus on the example of software service composition, but it should be understood that the same systems and/or methods also apply in other domains, e.g., where the service composition problem applies.

In the following one quickly summarizes principles and features of a typical embodiment of our invention. This summary is not intended to limit the scope of our claims. In a typical embodiment, our system and/or method initially receives inputs, in particular the workflow description with associated choice variables and variable value domains, a function that relates bindings to cost and/or quality properties of the workflow, and a minimum required approximation precision. This helps to calculate an approximation of the set of Pareto-optimal bindings such that the minimum required approximation precision is achieved (one assumes that a corresponding metric is defined to measure approximation precision—this invention is applicable for a wide range of approximation metrics). Certain exemplary techniques discussed herein are set apart from prior art in multi-objective workflow optimization since a) it works bottom-up on a hierarchical decomposition of the workflow (forming a hierarchy in which the elements are parts of the initially given workflow), constructing bindings for a composite workflow from bindings that have been constructed for its subworkflows, and b) the sets of bindings for workflow in the hierarchy are filtered before they are used for constructing bindings for higher levels in the hierarchy, wherein the filtering is performed in a way such that formal guarantees can be given on the precision loss. By bounding the precision loss during every filtering operation and calculating a suitable bound, it can be guaranteed that the final precision requirements are met.

### 1.1. Quality-Driven Service Selection

The development of SOA applications is often divided into two phases. In the first phase, one models the SOA application as abstract workflow. Tasks within this workflow are associated with specific functions that can be accomplished by a set of available services. In the second phase, tasks are mapped to specific services (this mapping is called a binding) based on their non-functional properties. Note that the second phase may be repeated several times for the same abstract workflow (in the extreme case once per invocation). The number of possible selections grows exponentially in the number of workflow tasks. Because of the huge number of possibilities, developers need help in finding a binding which realizes the best QoS for them. The optimization problem of finding an optimal selection of services has been coined Quality-Driven Service Selection (QDSS), or also Quality-Driven Service Composition and the term QDSS in used in the present application.

QDSS is a multi-criteria optimization problem (the different QoS properties correspond to different criteria). So, one service selection may minimize the response time of an orchestration, while another selection minimizes the monetary cost. One cannot say a priori which one of these possibilities is better.

The QDSS problem exists in two variants, namely Utility-Based Quality Driven Service Selection (UQDSS) and Pareto Quality-Driven Service Selection (PQDSS), that cope differently with this issue.

In UQDSS, an additional utility function is specified that defines priorities or weights for the different QoS parameters. Therefore, one can decide which selection realizes the optimal trade-off between different QoS properties. The utility function basically transforms the multi-dimensional optimization problem into a one-dimensional optimization problem. The solution to the UQDSS problem is one selection that is optimal according to the utility function. In PQDSS, no additional utility function is specified and the multi-dimensional nature of QDSS is preserved. Solving the PQDSS problem does not yield only a single solution, but a set of service selections that are Pareto-optimal. One calls a binding Pareto-optimal if no other binding exists that is better in some QoS dimensions and equivalent in all others.

Optimality vs. Pareto-Optimality.

Different measures of optimality are illustrated in FIGS. 1A and 1B. The QoS that different selections realize is represented as circles within a two-dimensional QoS space (response time and reliability). In FIG. 1A, assuming that a simple utility function (the shorter the response time the better) has been defined as it is done in UQDSS. The optimal binding according to this measure is marked in black. In FIG. 1B, one does not assume a specific utility function as it is done in PQDSS. Pareto-optimal bindings are marked in black.

### 1.2. Why to Search for Pareto-Optimal Solutions

PQDSS seems intuitively harder to solve than UQDSS since the result is a whole set of optimal bindings instead of only one. In the following paragraphs two reasons why it is worth to invest into finding a representative set of Pareto-optimal bindings are discussed:

### 1. Direct Choice.

In UQDSS, users select bindings indirectly by specifying a utility function out of a family of allowed functions. However, simple utility functions cannot fully reflect the real preferences of the user. Complex utility functions are too tedious for the user to specify, see references [4, 5], and many UQDSS algorithms work only with simple utility functions. Without having an overview of the possible solutions, it is difficult for users to optimally configure the utility function. For instance: Often, a linear weighting between different normalized QoS values is used as utility function together with the possibility to define minimum QoS requirements on the different dimensions. Minimizing the response time for a minimum reliability of 90% may seem like a reasonable choice. It is however possible that a reliability of 89% enables solutions with significantly lower response time. Having a representative set of Pareto-optimal solutions allows them to be presented to the user in various ways (e.g. graphically) and lets users select directly. Also, the user can perform arbitrary sort and filter operations on this set efficiently.

### 2. Efficient Multi-Selection.

Assume one has to generate different bindings for the same workflow. Consider for instance a popular workflow that is invoked by different users with different QoS preferences. Bindings are selected automatically by the middleware for every invocation and the utility function depends on the general system context. Assuming that the set of available services does not change too frequently, it is possible to calculate a set of Pareto-optimal solutions first, store it, and then select the best binding according to the current utility function. The selection of the best binding can be done in one traversal of the Pareto set and is therefore very efficient. It is not necessary to invoke the selection algorithm for every execution of the workflow, and the overall efficiency potentially increases.

Finally, note that every method for PQDSS also yields a method for UQDSS, since a binding with optimal utility value can be selected out of the Pareto-optimal bindings in a second step.

Typical examples of methods known in the art are disclosed in the following publications
“Systems and methods for dynamic composition of business processes”, US 2012/0053970 A1 (multi-objective Web service selection using population-based optimization algorithms such as genetic algorithms)
“Selection of Web services by service providers”, U.S. Pat. No. 7,707,173 B2 (single-objective Web service selection using solver components such as constraint solvers or integer linear programming solvers)

### 1.3. Contribution and Outline

Existing work on PQDSS can be divided into two categories. Approaches of the first category use heuristic methods such as genetic algorithms, see reference [6]. These scale polynomially in the problem size (here: number of workflow tasks and service candidates) but do not offer formal guarantees on approximation precision. Approaches of the second category—one calls them exact methods—calculate the full set of Pareto-optimal solutions, see reference [7] and hence have optimal approximation precision. However, their time complexity grows exponentially in the problem size since the number of Pareto-optimal solutions may do so, too. Such approaches do therefore not scale to larger problem instances.

In certain exemplary embodiments, an algorithm is described that does not belong to either of those two categories. Instead, certain exemplary embodiments aim at the sweet spot between the two extremes.

Certain exemplary embodiments describe three algorithms for PQDSS, in particular a Fully Polynomial-Time Approximation Scheme (FPTAS), see reference [8] for PQDSS. This term is applicable since the algorithm i) allows users to specify a desired approximation precision, ii) provides formal guarantees that this precision is achieved, and iii) the time complexity is polynomial in the problem size and in the inverse of the selected precision.

The following three sections (Sections 4, 5, and 6) will each present and formally analyze one algorithm for PQDSS derived from the algorithmic scheme according to certain exemplary embodiments. Those algorithms differ by approximation precision and their time and space complexity. The first algorithm, named A-EXACT, returns a complete set of Pareto-optimal bindings. This leads to a time and space complexity which is exponential in the number of workflow tasks. This algorithm is therefore applicable for small problem instances. The second algorithm, named A-HEUR and presented in Section 5, improves on the first by offering polynomial time and space complexity in all problem parameters. Instead of the real Pareto-frontier, it returns however only an approximation. One will show that the QoS of the returned bindings can be arbitrarily far from the QoS of the real Pareto-optimal bindings so no precision guarantees can be given. The cause of this problem is analyzed in Section 5. In Section 6, one starts from this analysis to design the third and final algorithm, named A-FPTAS because it represents a fully polynomial time approximation scheme. This algorithm combines polynomial time complexity with precision guarantees.

Table 1 summarizes the different algorithms, their properties and the sections in which they are presented.

TABLE 1
Summary of Presented Algorithms

| Nr. | Section | Name | Precision | Complexity |
|---|---|---|---|---|
| 1 | 4 | A-EXACT | Optimal | Exponential |
| 2 | 5 | A-HEUR | No Guarantees | Polynomial |
| 3 | 6 | A-FPTAS | Error bounded | Polynomial |

An experimental evaluation follows in Section 7 where one shows that A-FPTAS outperforms heuristic approaches in terms of precision and exact methods in terms of efficiency. In Section 8, then a comparison is made with related work before results are discussed and summarized in Section 9.

In certain exemplary embodiments, a computer-implemented method for approximating the set of Pareto-optimal bindings for a workflow comprising choice variables is provided. Each binding assigns each of said variables to one value. An input workflow description comprising a set of variables, a set of alternative values for each of said variables, a function relating said variables in said workflow with cost and/or quality properties of said workflow, and a minimum precision, are received. A hierarchical decomposition comprising at least a first node and a second node is associated with said input workflow. Said first node is the parent of said second node and both nodes are associated with workflow descriptions such that all variables comprised in the workflow description associated with said second node are also comprised in the workflow description associated with said first node. For the second node a set of bindings, each binding associating each variable of the workflow associated with said second node with a value is computed via at least one processor. For the first node a set of bindings, each binding associating each variable of the workflow associated with said first node with a value is computed via at least one processor. Each binding is computed for said first node is constructed out of a binding computed for said second node such that said binding computed for said first node assigns all variables comprised in the workflow associated with said second node to the same values as the binding for said second node it was constructed from. The quality and/or cost properties according to the function received is associated with each of the bindings computed for said first node. The set of bindings associated with the first node is filtered to possibly reduce its size, said filtering being executed such that the minimum precision requirements are respected.

In certain exemplary embodiments, a computer device linked to input devices, output devices, and to a readable medium carrying a program is provided. Said program, when operating in connection with said computer device, causes said computer device to at least perform instructions corresponding to the steps in the method in the preceding paragraph. Similarly, in certain exemplary embodiments, a non-transitory computer readable storage medium tangibly stores a program comprising instructions that, when executed by a computer system having at least one processor and a memory, cause the computer system to at least take actions corresponding to the steps in the method in the preceding paragraph.

In addition to the features of either of the two previous paragraphs, in certain exemplary embodiments, at least one of the variables contained within the description of said input workflow may comprise a choice between alternative services for a task within said input workflow; alternative workers for a task within said input workflow; and/or alternative workflow parts of said input workflow.

In addition to the features of any of the three previous paragraphs, in certain exemplary embodiments, the set of considered cost and/or quality properties may comprise at least one of the following properties or a combination thereof: execution time, execution cost, energy consumption, availability, reliability, throughput, reputation, or a measure of result quality.

In addition to the features of the previous paragraph, in certain exemplary embodiments, the measure of result quality may comprise result precision or result confidence or result resolution.

In addition to the features of any of the five previous paragraphs, in certain exemplary embodiments, formulas may be used that express at least one of the cost and/or quality properties of the workflow associated with said first node as a function of at least one of the cost and/or quality properties of the workflow associated with said second node.

In addition to the features of any of the six previous paragraphs, in certain exemplary embodiments, said precision requirements for at least one of the cost and/or quality properties of said input workflow may be defined using one of the following: a) a resolution referring to a space within which cost and/or quality properties of said input workflow can be represented; b) a distance between cost and/or quality properties of bindings from variables within said input workflow to values that said method computes and cost and/or quality properties of possible bindings; and c) a percentage or multiplicative factor being used to compare cost and/or quality properties of possible bindings from variables within said input workflow to values with bindings that said method computes.

In addition to the features of any of the seven previous paragraphs, in certain exemplary embodiments, information that is used to compare cost and/or quality properties of bindings from variables within said input workflow to values may be associated with said first node or said second node or both.

In addition to the features of the previous paragraph, in certain exemplary embodiments, n the associating of the additional information with said first node or said second node or both may comprise: a) computing, for each cost and/or quality property, the range of values that could be reached by bindings associated with the second node and with the first node; b) selecting, for each cost and/or quality property, a subset of the range associated with the first node; and c) applying said subset to the range associated with the second node, thus reducing the range associated with said second node to a critical range.

In addition to the features of any of the nine previous paragraphs, in certain exemplary embodiments, the approach may further include at least one of: a) presenting to the user an approximated set of Pareto-optimal bindings from variables within said input workflow to values or a subset of said bindings; b) presenting to the user information about cost and/or quality properties of an approximated set of Pareto-optimal bindings from variables within said input workflow to values or of a subset of said bindings; c) allowing the user to make a selection between binding from variables within said input workflow to values; and/or d) automatically selecting between bindings from variables within said input workflow to values.

It will be appreciated that in computer device related embodiments, the computer device may be a standalone device or a plurality of networked devices. Similarly, the readable medium may be a hardware device or a network.

The features, aspects, and advantages of the exemplary embodiments described herein may be combined or recombined in any suitable combination or sub-combination to achieve yet further embodiments.

### BRIEF DESCRIPTION OF THE DRAWINGS

The present invention will be better understood from the following description of embodiments and from the appended drawings in which:

FIGS. 1A and 1B illustrate optimal bindings for different measures, with FIG. 1A showing a Time-Optimal binding and FIG. 1B showing a Pareto Frontier

FIGS. 2A-2C illustrate a running example;

FIG. 3 illustrates an example of splitting workflows into fragments;

FIGS. 4A-4B illustrate QoS versus QoS Levels for Example Bindings;

FIG. 5 includes pseudo-code for a Main Function;

FIG. 6 includes pseudo-code for a function InsertPareto;

FIG. 7 illustrates a call hierarchy between presented functions;

FIGS. 8A-8C illustrate how different algorithms (including the A-EXACT, A-HEUR, and A-FPTAS algorithms, respectively) filter bindings for workflow fragments;

FIG. 9 includes pseudo-code for an A-EXACT algorithm;

FIG. 10 includes pseudo-code for an A-HEUR algorithm;

FIG. 11 illustrates how total QoS ranges are calculated (bottom-up);

FIG. 12 illustrates a problem when Scaling w.r.t. total QoS ranges;

FIG. 13 includes pseudo-code for an A-FPTAS algorithm;

FIG. 14 illustrates scaling w.r.t. critical QoS ranges;

FIG. 15 illustrates how good approximations of child Pareto sets yield good approximation for parent workflow;

FIG. 16 includes pseudo-code for calculating critical ranges;

FIG. 17 illustrates calculation of critical ranges (top-down);

FIG. 18 illustrates the critical ranges for the running example;

FIGS. 19A-C illustrate experimental results;

FIG. 20 illustrates the maximum Pareto error

FIG. 21 illustrates a QoS change outside the critical range of the child fragment that does not change the QoS level of the parent;

FIG. 22 illustrates QoS change in the parent bounded by the QoS change in the child fragment;

FIG. 23 illustrates a QoS-Level difference in the parent bounded by the sum of the QoS-Level differences in the children;

FIG. 24 illustrate a block-diagram of a device suitable to carry out the method of the invention; and

FIG. 25 illustrates a high-level flow diagram depicting the main steps of a typical embodiment.

### DETAILED DESCRIPTION

### 2. System Model and Assumptions

All definitions that are used throughout this application can be found in this section. The introduced concepts are illustrated by a running example. A summary table can be found at the end of this section.

Several fundamental assumptions that are common in QDSS, see reference [9], are made. First, one assumes that reliable information about non-functional properties of services is available. Second, one assumes that estimates concerning the probability of different workflow execution paths are available. Such information is essential for QDSS as outlined for instance by Ardagna et al., see reference [10]. It can be either estimated in domain-specific ways or from the traces of past executions. A formal model for QDSS which is based on these assumptions will be presented.

### 2.1. Workflows and Services

[symbol] denotes the set of Web services in the registry.

### Definition 1. Simple Task, Candidate Services

A simple task represents a specific operation that has to be performed by one service invocation. A task T is associated with a subset of functionally equivalent candidate services, denoted by candidates (T)⊂ [symbol] that are able to perform this operation (one requires that this set is never empty). One assumes that all simple tasks within a complex workflow (see Definition 2) are distinguished by a unique ID.

### Definition 2. Workflow, Child/Parent Workflow

One defines workflows recursively using two axioms. i) Every simple task is a workflow. ii) Let c₁, . . . , c_{N} workflows, then their sequential, parallel, conditional (exclusive choice), or iterated execution is also a workflow W. One denotes the aforementioned possibilities by SEQ<c₁, . . . , c_{N}>, PAR<c₁, . . . c_{N}>, CHC<c₁, . . . , c_{N}>, and LOOP<c₁>, respectively¹. One calls the cᵢ child workflows (or subworkflows) of W, W the parent of the cᵢ, and W is a complex workflow. The function childFlows(W) returns the set of child workflows for a complex workflow W. The predicates isSimple(W) and isComplex(W) distinguish between simple and complex workflows. ¹Note that our formal model abstracts certain details away (e.g. choice and stopping conditions) that would be crucial for executing the workflow. Still, the model is sufficiently detailed for PQDSS. Information about the probability that certain branches in a choice construct are executed for instance, is implicitly represented in the QoS aggregation function (see Definition 7).

### Definition 3. Empty Workflow

One calls a workflow without any simple tasks empty. The predicate isEmpty(W) captures whether W is empty. One often refers to empty workflows by the symbol ∈. Unless noted otherwise, the theorems about workflows implicitly assume that the workflow is not empty.

A running example is the following.

### Example 2

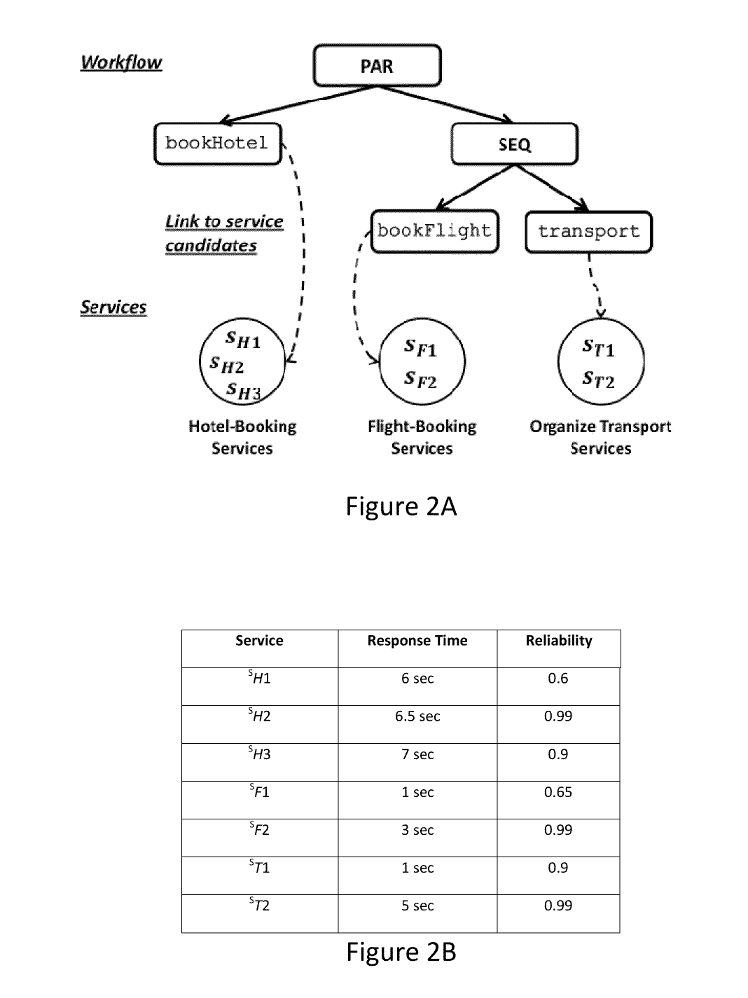

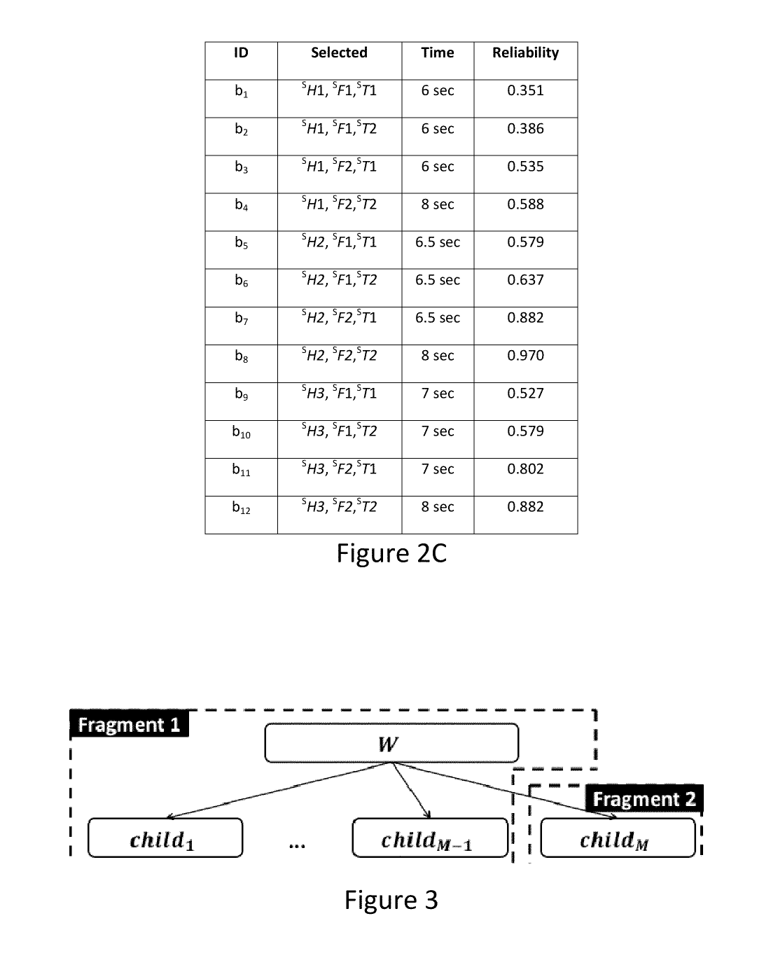

One assumes the need to go to a conference and one has to book a hotel close to the conference, a flight, and a transportation from the airport to the hotel. Let bookHotel, bookFlight, transport be simple tasks, representing booking a hotel room, booking a flight, and organizing transport respectively. One can book a flight and the hotel room in parallel since conference dates and location are fixed. Booking a transport from airport to the conference location requires however to know the destination airport. Then Wᵣₑ=PAR<bookHotel,SEQ<bookFlight,transport>> describes a corresponding workflow. The workflow is represented as tree in FIG. 2A. Wᵣₑ has the subworkflows bookHotel and SEQ<bookFlight,transport>.

One will use the symbol Wᵣₑ throughout the remainder of the present description to refer to this workflow.

Definition 4. Splitting Workflows into Fragment

The function Split(W) for splitting a complex workflow W into two fragment workflows is introduced The result is a two tuple <W₁,W₂>=Split(W) where W₁ is the last child workflow (assuming an implicit order between child workflows), and W₂ is derived from W by cutting child W₁. One calls W₁ and W₂ the fragments of W. It is W₂=∈if W has only one child. More formally, assume W=C<c₁, . . . c_{N}> where {c₁, . . . , c_{N}} are the child flows of W and C∈{SEQ,PAR,CHC,LOOP} is the control flow between them. Then one has <C_{N},C<C₁, . . . , C_{N-1}>>=Split(W). FIG. 3 illustrates the definition.

### Example 3

It is <W₁, W₂>=Split(Wᵣₑ) where W₁=SEQ<bookFlight,transport>, and W₂=PAR<bookHotel>.

### Definition 5. Nested Fragments

For a given workflow W, one calls the set containing W, its fragments, the fragments of its fragments etc. the set of nested fragments. One denotes the set of nested fragments by the function NFrags and provide a formal, recursive definition: If W is a simple task, one has NFrags(W)={W}. If W is complex and <W₁, W₂>=Split(W) then NFrags(W)=({W,W₁,W₂})∪NFrags(W₁)∪NFrags(W₂))\{∈} (so one do not take into account the empty task).

### Example 4

The set NFrags(Wᵣₑ) contains the elements Wᵣₑ, PAR<bookHotel>, bookHotel, SEQ<bookFlight,transport>, SEQ<bookFlight>, bookFlight, and transport.

### Definition 6. Binding

For a workflow W, denote by T⊂NFrags(W) the subset of nested fragments that are simple tasks. Every simple task is associated with a set of candidate services. A binding for W is a total function binding:T→ [symbol] . It maps every task T to exactly one of its candidate services. A workflow with a binding can be executed. By [symbol] (W) one denotes the set of all possible bindings for W.

### Remark 1.

Note that according to our definition, a binding for a workflow W is at the same time a binding for every nested fragment of W.

### Example 5

### FIG. 2C shows all possible bindings for the workflow in FIG. 2A, using the services in FIG. 2B. Note that one reports the selected services for a binding as set (column Selected) since in the example no service can be used for two different workflow tasks. In general, one service may be applicable for several tasks within the same workflow and therefore one models bindings as functions in general. In the next subsection, how QoS values for specific bindings can be estimated is explained.

### 2.2. Quality of Service

Functionally equivalent services may differ in their Quality of Service (QoS) properties such as (average or worst case) response time and reliability. One denotes by [symbol] the set of QoS attributes. Assuming a fixed ordering between those attributes, services are described by [symbol] -dimensional QoS vectors of positive real values. One denotes QoS vectors in bold font (e.g. q) to differentiate them optically from scalar values. One refers to the specific QoS value for attribute a∈ [symbol] within QoS vector q by q^{a}.

One define the operations+,− and × between QoS vectors as component-wise addition, subtraction, and multiplication. One can estimate the QoS properties of a workflow when using a specific binding from the QoS properties of the selected services (one assumes that average and worst case QoS values are available in the registry).

### Definition 7. QoS Estimation

Function QoS(W,b) estimates the QoS for workflow W if binding b is used. The QoS of a simple task correspond to the QoS of the selected service and can be directly obtained from the registry. QoS estimates for complex workflows are aggregated from the QoS estimates of the two fragments. For a complex workflow W, one defines a vector of aggregation functions QoSAF(W). One considers the binary aggregation functions minimum min□□ ((q1,q2) [symbol] min□(q1,q2)), maximum max□□((q1,q2) [symbol] max□(q1,q2)), weighted sum Σ□((q1,q2) [symbol] qw₁·q1+qw₂·q2) (with weights qw₁,qw₂∈[0,1]), and product Π□((q1,q2) [symbol] q1·q2). By q=QoSAF(W)(q1,q2) one denotes the vector that results from the component-wise application of the aggregation function for every single attribute (q^{a}=QoSAF^{a}(W)(q1^{a},q2^{a})) One gives a recursive definition of QoS where one sets <W₁,W₂>=Split(W), q1=QoS(W₁,b), q2=QoS(W₂,b) if W is a complex workflow:

$$QoS ( W , b ) = \{ \begin{matrix}if W is a simple task \text{:} \\ QoS of b ( W ) ∈ 𝕊 \\ if W is complex \text{:} \\ QoSAF ( W ) ( q 1 , q 2 )\end{matrix} \qquad ( 1 )$$

### Example 6

Ordering response time before reliability in the vector components, one has QoSAF(Wᵣₑ)=(max□□,Π□), and QoSAF(SEQ<bookFlight,transport>)=(Σ□,Π□) where the weights of the weighted sum are all 1. FIG. 2C shows bindings with estimated QoS properties (for instance QoS(Wᵣₑ,b₁)=(6,0.351)).

The following definitions classify QoS attributes in two orthogonal dimensions.

### Definition 8. Positive/Negative QoS Attributes

For some QoS attributes such as reliability, a higher value corresponds to better quality. One calls them positive attributes and denote the set of positive attributes by [symbol] ⁺∉ [symbol] . For other QoS attributes such as response time, a higher value corresponds to worse quality. One calls them negative attributes and denote the set of negative attributes by [symbol] ⁻∉ [symbol] .

### Definition 9. Bounded/Unbounded QoS Attributes

Bounded attributes such as reliability have an a priori bounded value domain (for reliability the interval [0,1] since it is a probability). Unbounded attributes such as response time have a priori no bounded value domain (maximum response time depends on the number of tasks and available services, it can become arbitrarily large).

### Definition 10. QoS Range

One uses the term range for multi-dimensional intervals in the QoS space. A range R=<LB,UB> is described by two QoS vectors LB (lower bound) and UB (upper bound) such that ∀a∈ [symbol] :LB^{a}≦UB^{a}. One denotes the lower bound of a range R by RL and the upper bound by R_{U}. One denotes the width of a range R by

$$\vert R \vert = {max}_{a ∈ 𝔸} \vert {R}_{U}^{a} - {R}_{L}^{a} \vert .$$

### Definition 11. Total QoS Range

Let W a workflow. The total QoS range for W, denoted by QR(W)=<TL,TU>, is defined by two QoS vectors such that for any attribute a∈ [symbol] :

$${TL}^{a} = {min}_{b ∈ 𝔹 ( W )} {QoS}^{a} ( W , b ) and {TU}^{a} = {max}_{b ∈ 𝔹 ( W )} {QoS}^{a} ( W , b ) .$$

### Example 7

One notes first response time then reliability in QoS vectors. So one has QR(Wᵣₑ)=<(6,0.351),(8,0.970)>.

When comparing QoS vectors in different quality dimensions, it is not convenient to always distinguish the cases of negative and positive attributes. In addition, one needs a criterion for deciding whether two QoS vectors are approximately equivalent. One addresses these two issues by the following definition.

### Definition 12. QoS Levels, Resolution, Grid

The function QostoLevel/(q,R,r) maps a vector of continuous QoS values q to a vector ql of discrete QoS levels, where a higher level corresponds to better quality and level 0 to worst quality. QoS levels are calculated with regards to (w.r.t.) a QoS range (not necessarily the total one) R=LB,UB> and a resolution r. QoS values are mapped to QoS levels as follows. For every attribute a, the range (<LB^{a},UB^{a}>) is equally partitioned into 1/r fields. QoS values that fall into the same field are mapped to the same QoS level. QoS values outside the range are treated as if they would belong to the nearest field. One also says that a range together with a resolution define a grid within the multi-dimensional QoS space. Grid cells correspond to the points that would be mapped to the same vector of QoS levels. One defines ql=QoStoLevel(q,R,r) differently, depending on whether q∈ [symbol] is a positive or negative attribute:
1. If a is positive, one sets

$${ql}^{a} = ⌊ \frac{min □ ( {q}^{a} , {UB}^{a} ) - min □ ( {q}^{a} , {LB}^{a} )}{( {UB}^{a} - {LB}^{a} ) \cdot r} ⌋$$

2. If a is negative, one sets

$${ql}^{a} = ⌊ \frac{max □ ( {q}^{a} , {UB}^{a} ) - max □ ( {q}^{a} , {LB}^{a} )}{( {UB}^{a} - {LB}^{a} ) \cdot r} ⌋$$

One also introduces the following short notation for workflow W and binding b: QoSlevel(W,b,R,r)=QoStoLevel(QoS(W,b),R,r).

### Remark 2.

In QDSS, workflow QoS are most often scaled to a real number between 0 and 1 by comparing with best and worst possible values (e.g. see references [9, 10 and 11] to name just a few). Our definition of QoS levels actually combines the scaling with a discretization of the interval 0 and 1.

### Example 8

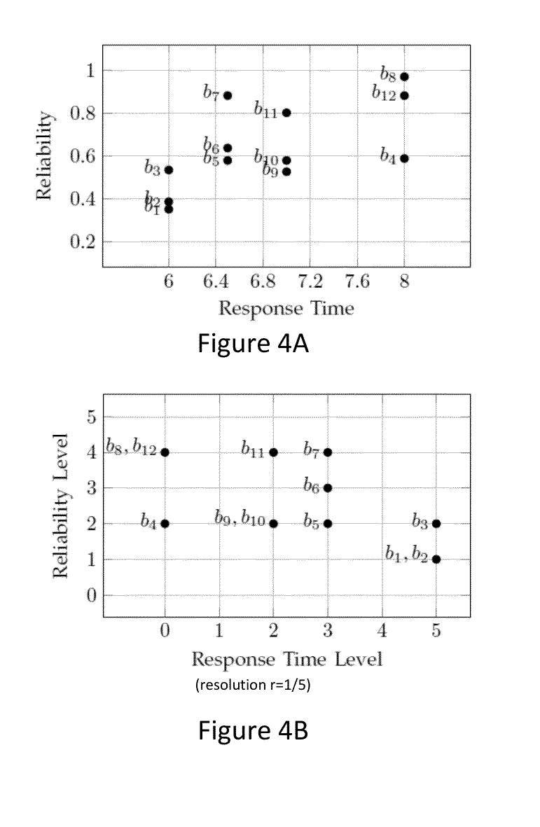

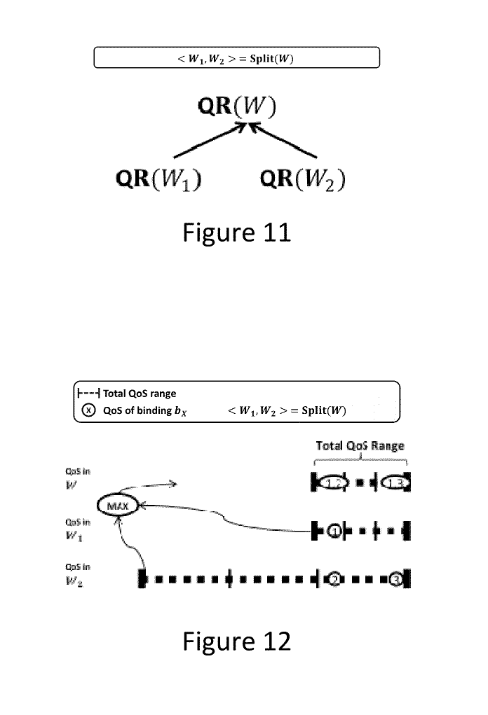

FIG. 4A represents the QoS of the bindings from FIG. 2C graphically. Every binding is represented as dot within the two-dimensional quality space (response time and reliability). FIG. 11 represents the QoS levels of the same bindings. Bindings correspond to dots within the two-dimensional quality level space (response time level and reliability level). One calculates QoS levels w.r.t. resolution

$$r = \frac{1}{5}$$

(therefore QoS levels are integers between 0 and 5) and range QR(Wᵣₑ). Consider for instance binding bₐ. Its response time is maximal among all bindings, therefore its response time level is minimal (response time is a negative QoS). Its reliability is also maximal, therefore its reliability level is maximal as well (reliability is positive QoS). The grid in FIG. 4A symbolizes the grid spanned by the total QoS range and resolution ⅕. Bindings b₉ and b₁₀ fall into the same grid cell in FIG. 4A, therefore they are mapped to the same QoS levels in FIG. 4B. Note that QoS levels are discrete numbers, therefore all bindings map to grid intersection points in FIG. 4B.

### 2.3. Pareto-Optimality

### Definition 13. Dominance, Pareto-Optimality

Let q₁,q₂ two QoS vectors. q₁ dominates q₂, denoted q₁>q₂, if and only if i) q₁ has better or equivalent QoS to q₂ in all attributes, ∀a∈ [symbol] ⁺:q₁^{a}≦q₂^{a} [symbol] ∀a∈ [symbol] ⁻:q₁^{a}≦a₂^{a}, and ii) the QoS of q₁ is strictly better than the one of q₂ for at least one attribute, ∃a∈ [symbol] ⁺:q₁^{a}>q₂^{a} [symbol] ∃a∈ [symbol] :q₁^{a}<q₂^{a}, q₁ is QoS equivalent to q₂, denoted q₁=q₂, if one has ∀a∈ [symbol] :q₁¹=a₂^{a}. one sets q₁>q₂ [symbol] q₁>q₂∀q₁=q₂. Let R a QoS range, r a resolution, and qlᵢ=QoStoLevel(qᵢ,R,r) for i∈{1,2}. one says that q₁ dominates q₂ w.r.t. range R and resolution r, denoted q₁>_{R,r} q₂, if i) ql₁ has higher or equivalent QoS level for every attribute (∃a∈ [symbol] :ql₁^{a}≧ql₂^{a}), and ii) ql₁ has higher QoS level than ql₂ in at least one attribute (∃a∈ [symbol] :ql₁^{a}>ql₂^{a}). one says that q₁ and q₂ are equivalent w.r.t. R and r, denoted q₁=_{R,r} q₂, if the QoS levels of ql₁ and ql₂ are equivalent (∀a∈ [symbol] :ql₁^{a}=ql₂^{a}). One sets q₁>=_{R,r} q₂ [symbol] q₁>_{R,r} q₂ [symbol] q₁=_{R,r} q₂.

Let b₁,b₂∈ [symbol] (W) two bindings for workflow W. b₁ dominates b₂ for workflow W, denoted by b₁>w b₂, if and only if QoS(W,b₁)>QoS(W,b₂). One introduces the relationships b₁=_{w} b₂, b₁>_{w} b₂, b₁>_{w.R.r} b₂, b₁=_{W.R.r} b₂, and b₁>_{W.R.r} b₂ in the analogous way. One says that a binding b₁ is Pareto-optimal for workflow W if no binding b₂∈in [symbol] (W) exists such that b₂>_{w} b₁.

### Example 9

Considering the bindings from our running example (see FIG. 11), one has (among others) the relations b₇>b₁₁, b₇>b₄, and b₂>b₁. Bindings b₂, b₇, and b₈ are Pareto-optimal since no other binding dominates them (in FIG. 11: no other binding is at the upper-left). Let resolution

$$r = \frac{1}{5}$$

and R=QR(Wᵣₑ). One has for instance b₁₂=_{R.r} b₈ (see FIG. 11) and b₇>_{R.r} b₄.

### Definition 14. Pareto Set

A Pareto set for workflow W (also: Pareto frontier) is a set B={<bᵢ,qᵢ>} of two-tuples such that i) bᵢ is a binding for W and qᵢ=QoS(W,bᵢ) its QoS, and ii) for every binding b₁ ∈ [symbol] (W), there is a binding b₂∈B which is at least as good in all QoS dimensions (b₂>_{w} b₁). One writes Pset(B,W) if B is a Pareto set for W.

Note that several Pareto sets may exist for the same workflow since one requires only one among several QoS-equivalent bindings.

### Definition 15. Pareto Error, Approximated Set

A set B={<bᵢ,qᵢ>} of two-tuples is an approximated Pareto set for workflow W w.r.t. range R, resolution r, and with Pareto error e, denoted as Psetₑ (B,W,R,r), if i) bᵢ is a binding for W and qᵢ=QoS(W,bᵢ) its QoS, and ii) for every binding b₁∈ [symbol] (W), there is a binding b₂∈B whose QoS levels (calculated w.r.t. R and r) are not worse by more than e levels than the ones of b₁ for every QoS dimensions (∀a∈ [symbol] :QoSlevel^{a}(W,b₂R,r)≦QoSlevel¹(W,b₁,R,r)−e). One introduces the short notation Psetₑ(B,W,r):=Psetₑ(B,W,QR(W),r), assuming scaling w,r,t. total QoS ranges by default.

### Example 10

Considering the bindings bᵢ from FIG. 2C with QoS qᵢ, the set {<bᵢ,qᵢ>|i∈{3,7,8}} is a Pareto set for Wᵣₑ (see FIG. 11). The set {<bᵢ,qᵢ>|i∈{3,7}} forms an approximated Pareto set for range QR(Wᵣₑ) and resolution

$$r = \frac{1}{5}$$

with error 0 (see FIG. 11). The sets {<bᵢ,qᵢ>|i∈{3,11}} and {<bᵢ,qᵢ>|i∈{6,2}} are both approximated Pareto sets with error 1. The set {<b₅,q₅>} is an approximated Pareto set with error 2

The formal problem statement is the following.

### Definition 16. PQDSS Problem

The tuple [symbol] =< [symbol] , [symbol] , [symbol] > describes a PQDSS problem where [symbol] is a set of QoS attributes (associated with all necessary information about attributes such as which attributes are positives/negatives), [symbol] a set of services with associated QoS vectors, and [symbol] a workflow whose simple tasks are mapped to services in [symbol] and whose complex fragments are mapped to corresponding QoS aggregation functions. A solution is an approximated Pareto set B for [symbol] . One evaluates the optimality of the solution by the Pareto error e, calculated w.r.t. the total QoS range of [symbol] and a given target resolution tr (e.g. e is the smallest positive integer such that Psetₑ(B, [symbol] ,tr)).

### Remark 3.

Note that the algorithms one will present, implicitly assume that loop constructs in [symbol] have been replaced, using for instance the peeling technique proposed by Ardagna et al, see reference [10].

### 2.4. Notations and Assumptions for Formal Complexity and Precision Analysis

One uses the following parameters to describe the difficulty of a given PQDSS problem [symbol] =< [symbol] , [symbol] , [symbol] >:
A=| [symbol] |(number of QoS attributes).
S=| [symbol] |(number of services).
N=|NFrags( [symbol] )|(number of nested fragments).

### Example 11

The running example describes a PQDSS problem with A=2 QoS attributes (response time and reliability), S=7 services in the registry, and the example workflow Wᵣₑ has N=7 workflow fragments.

For some of the algorithms that are analyzed, time and space complexity depend additionally on a user-defined target resolution tr (or on an internal resolution r, derived from the target resolution) which allows to trade approximation precision against efficiency: the finer the resolution, the closer the QoS of the returned bindings to those of the real Pareto frontier and the higher time and space requirements.

During our asymptotic complexity analysis, one considers W, S, and resolution tr (respective r) as variables and A as constant. One outlines the reasons behind this assumption. New Web services may be added to the registry at any time, the number of workflow activities and the resolution are chosen by the user. Introducing new QoS attributes (that are not calculated from existing ones) is more difficult. The monitoring infrastructure must be adapted to measure the new QoS attribute and data about services must be collected (even if service providers advertise the QoS themselves, some verification mechanism should be implemented). Benchmarks in QDSS typically use low numbers of QoS attributes in comparison to the number of services and tasks (e.g. 5 attributes, up to 80 tasks and up to 40 services per task, see reference [8]).

One further assumes that elementary arithmetic operations can be performed in 0(1) time and that elementary data types such as numbers, booleans, and pointers are in 0(1) space.

### 2.5. Summary

Table 2 summarizes the symbols and functions introduced in this section.

TABLE 2
Summary of Introduced Symbols

| Symbol | Semantic |
|---|---|
| Wᵣₑ | Running example workflow |
| [symbol] | Set of services in registry |
| [symbol] / [symbol] ⁺/ [symbol] ⁻ | Set of all/positive/negative QoS attributes |
| [symbol] (W) | All possible bindings for workflow W |
| isEmpty(W)/ | Whether workflow W is empty/simple |
| isSimple(W)/ | task/complex workflow |
| isComplex(W) | |
| candidates(W) | Candidate services for simple task W |
| childFlows(W) | Child workflows of complex flow W |
| Split(W) | Splits complex flow W into its last child |
| | workflow and the remainder |
| NFrags(W) | Set of nested fragments of workflow W |
| QoSAF(W) | Aggregation functions for aggregating QoS for |
| | different attributes in W out of QoS of fragments |
| QoS(W, b) | Estimated QoS for workflow W with binding W |
| QoSlevel(W, b, R, r) | Estimated QoS levels (relative to range R and |
| | resolution r) for workflow W with binding b |
| QoStoLevel(q, R, r) | Discrete QoS levels for continuous QoS vector q |
| | relative to range R and resolution r |
| QR(W) | Total QoS range for workflow W over all |
| | possible bindings |
| Pset(B, W) | Holds if B is Pareto set for workflow W |
| Perrₑ(B, W, R, r) | Holds if B is an approximated Pareto set for |
| | workflow W with Pareto error e w.r.t. range R |
| | and resolution r |
| A | Nr. of QoS attributes |
| S | Nr. of services |
| N | Nr. of workflow fragments |
| tr/r | Target resolution/internal resolution |

### 3. An Algorithmic Scheme for PQDSS

In Section 3.1, one describes an algorithmic scheme for solving the PQDSS problem as defined in Section 2.3. The pseudo-code of this scheme refers to auxiliary functions that are not specified in this section, yet. Sections 4 to 6 will derive three different algorithms from the scheme by presenting alternative definitions of those functions. Section 3.2 explains in detail how algorithms are derived from the scheme.

### 3.1. Description of Algorithmic Scheme

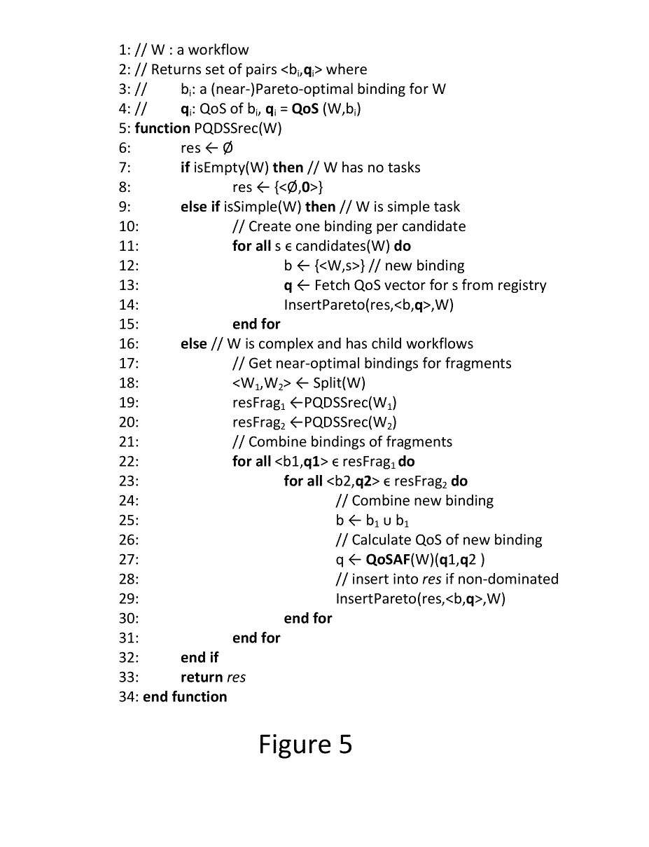

One proposes a basic scheme for PQDSS that adopts the following principle: One calculates near Pareto-optimal bindings for a complex workflow out of near Pareto-optimal bindings of its fragments. FIG. 5 shows pseudo-code for function PQDSSrec. PQDSSrec finds near Pareto-optimal bindings for the input workflow W. The output is a set of tuples <b,q> where b represents a binding for W and q=QoS(W,b) the associated QoS vector. One now discusses the pseudo-code of PQDSSrec. While one discusses PQDSSrec, all line numbers refer to the pseudo-code in FIG. 5.

If W does not contain any simple tasks (line 7), PQDSSrec returns as binding the empty set (since no tasks have to be assigned to services) and 0 as QoS vector (vector of neutral elements for all QoS attributes). If W is a simple task (line 9), PQDSSrec produces one binding for every available service candidate (lines 11 to 15). Not all of them are Pareto-optimal. One uses the auxiliary function InsertPareto to make sure that only Pareto-optimal solutions remain in the result set (variable res) after all bindings have been produced. The call InsertPareto(res,<b,q>,W) inserts a new binding b for W with QoS q into res only if b is not dominated by any other binding in res. If the new binding is inserted, InsertPareto additionally deletes all bindings within res that are dominated by the new binding. One discusses the pseudo-code of InsertPareto later in this section and continues with the discussion of PQDSSrec.

If W is a complex workflow (line 16), PQDSSrec splits W into two fragments and calculates near Pareto-optimal bindings for those two fragments by recursive calls (lines 19 and 20). Bindings for the first (second) fragment of are stored in variable resFrag1 (resFrag2). Any binding from resFrag1 can be combined with any binding from resFrag2 into a binding for W. Using two nested for-loops (the outer loop spans from line 22 to line 31), one examines all possible combinations. Bindings correspond to sets of assignments. Therefore, one combines two bindings using the set union (line 25). One calculates the QoS of the new binding out of the QoS of the two bindings it was assembled from (line 27). One uses InsertPareto again, in order to insert new bindings into the result set while making sure that dominated bindings are deleted.

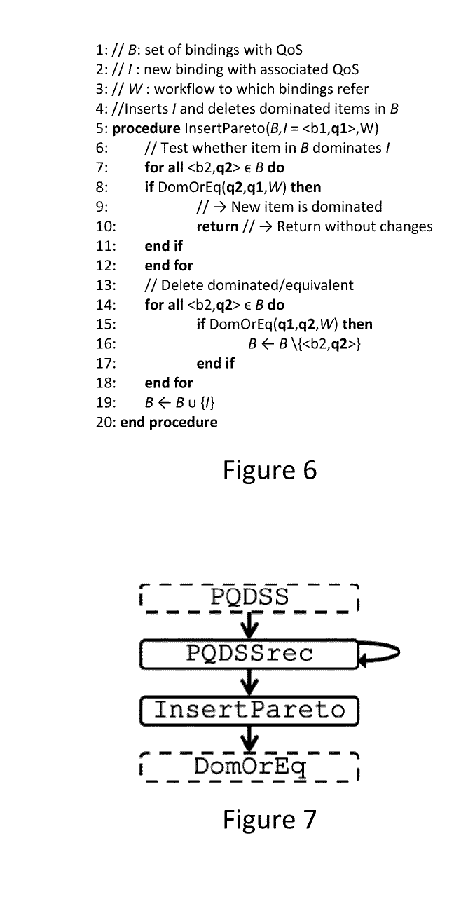

FIG. 6 shows the pseudo-code of function InsertPareto which was used by PQDSSrec. The goal of InsertPareto is to insert a new binding into a set of bindings while making sure that dominated bindings are deleted and only one out of several QoS-equivalent bindings remains in the set. The input is a set of bindings with QoS vectors, B, a new item I=<b1,q1> described by a binding b1 and its QoS vector q1, and the workflow W, to which b and the bindings in B apply. InsertPareto uses the auxiliary function DomOrEq to find out whether one QoS vector dominates another or is equivalent to it (DomOrEq(q₁,q₂,W) returns true if QoS vector q₁ dominates q₂ or is equivalent). In this section, one does not provide pseudo-code for DomOrEq. One presents several variants in the next sections. One now discusses the pseudo-code of InsertPareto. The line numbers in the following paragraph refer to the pseudo-code in FIG. 6.

InsertPareto first checks whether the new binding b₁ is dominated by or equivalent to any binding in B (lines 7 to 12). If this is the case, InsertPareto returns without changing B. If this is not the case, one first deletes all bindings within B that are dominated by or equivalent to b1 (lines 14 to 18), and finally insert binding b1 with its QoS q1 into B.

### 3.2. Outlook on Coming Sections

The pseudo-code presented in Section 3.1 is incomplete since one left the definition of function DomOrEq open. One presents three alternative definitions of DomOrEq, namely DomOrEq<V> for V∈{1,2,3} in the following sections. By InsertPareto<V> one denotes the variant of InsertPareto which uses DomOrEq<V> for comparing QoS vectors. Analogously, one refers by PQDSSrec<V> to the variant of PQDSSrec which uses InsertPareto<V> to filter bindings. Different variants of DomOrEq require different preparatory steps. One will therefore present a corresponding main function PQDSS<V> for every algorithm. PQDSS<V> performs preparatory steps for DomOrEq<V> and calls PQDSSrec<V> to approximate the Pareto set. In summary, one will derive algorithmic variant number V from our general scheme by specifying the following two functions:

i) the main function, PQDSS<V>, and
ii) the function for comparing QoS vectors, DomOrEq<V>.

FIG. 7 shows the call graph of the functions that were presented in this section (drawn with solid lines) and the functions that are going to be presented in different variants in the next sections (drawn with dashed lines). Calls are represented as arrows, pointing from the calling function to the called function.

One gives a quick outlook on the three algorithms that will be derived in the coming three sections. FIG. 7 shows how they filter bindings for a workflow fragment. A-EXACT is an exact algorithm and only filters out bindings that are not Pareto-optimal (see FIG. 7). A-HEUR achieves polynomial run time by dividing the total range of QoS values by a grid and keeping at most one binding per grid cell (see FIG. 7). This does however not yield any approximation guarantees. A-FPTAS calculates in a preprocessing step which part of the QoS range is critical for a given fragment, meaning that a difference within this range will influence the final workflow QoS. A-FPTAS divides only the critical part of the QoS range by a grid and keeps at most one binding per cell (see FIG. 7). This yields polynomial run time and precision guarantees.

### 4. Algorithm 1: Exact Calculation of Pareto Set

One presents algorithm A-EXACT which solves PQDSS problems exactly. The relationship between input and output of the main function is the following:
   Input: A PQDSS problem [symbol] =< [symbol] , [symbol] , [symbol] >
   Output: A Pareto set B for [symbol] s.t. Pset(B, [symbol] )
   One describes the algorithm in Section 4.1 and formally analyze it in Section 4.2.

### 4.1. Description of A-EXACT

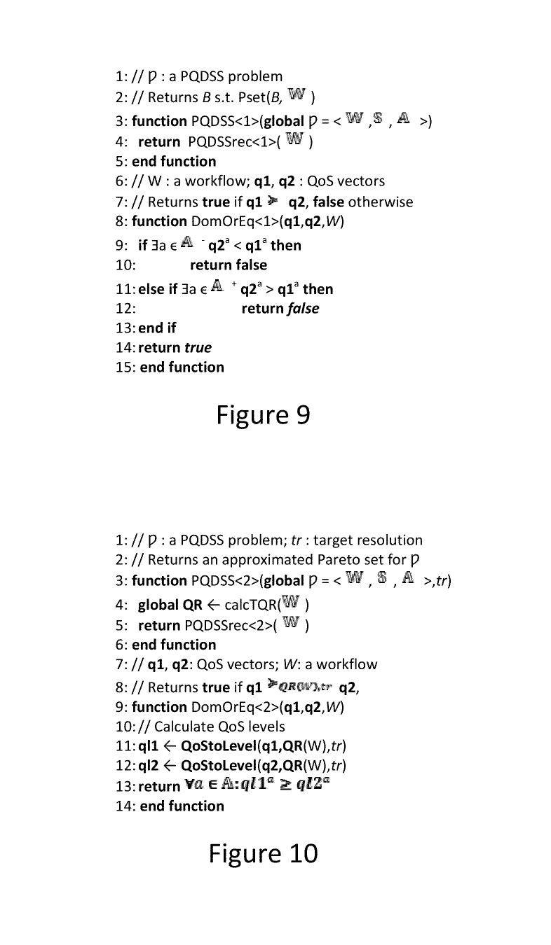

FIG. 9 shows the pseudo-code of the main function (PQDSS<1>) and the function that compares QoS vectors (DomOrEq<1>). Note that the input for the main function is declared as global, so all functions can access the variables [symbol] , [symbol] , [symbol] and without obtaining them as parameters. PQDSS <1> does not require any preparatory steps but calls PQDSSrec<1> directly, which assembles allPareto-optimal bindings for input workflow [symbol] . Function DomOrEq<1> checks whether QoS vector q1 dominates vector q2 or is equivalent to it. The function works as follows. It first tries to find any negative QoS attribute for which the QoS value in q1 is higher than the one in q2. If such an attribute is found, q1 neither dominates q2 nor is it equivalent to it. Otherwise, DomOrEq<1> checks whether a positive attribute can be found such that the QoS value in q1 is lower than the one in q2. Again, if such an attribute is found, DomOrEq<1> must return false. Otherwise, q1 dominates q2 or both vectors are equivalent and DomOrEq<1> returns true

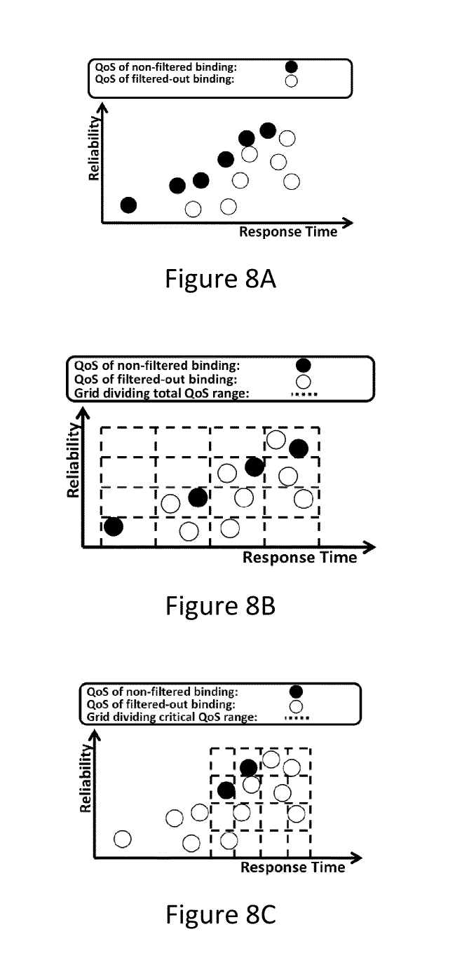

See FIG. 8A for an illustration of how A-EXACT filters bindings.

### 4.2, Analysis of A-EXACT

### 4.2.1. Approximation Precision

One proves that A-EXACT guarantees perfect approximation precision. The following lemma states that an improvement in all QoS for some workflow fragment can result in an improvement in the QoS of the parent workflow.

### Lemma 1.

Let W a complex workflow, <W₁,W₂>=Split(W) its fragments, and b⁺ and b two bindings for W. Then a b⁻>W₁ b and b⁻>=w₂ b together imply b⁻>_{w} b.

Proof: one considers the QoS aggregation functions product, (weighted) sum, minimum and maximum and QoS are represented by positive real numbers. All considered aggregation functions are monotone, therefore improving the QoS in a workflow fragment cannot worsen the QoS in the entire workflow.

### Theorem 1.

The call PQDSs<1>( [symbol] , [symbol] [symbol] ) returns a complete Pareto set for workflow [symbol] .

Proof: One conducts a proof by contradiction. Assume b is a Pareto-optimal binding for [symbol] and PQDSS<1>( [symbol] , [symbol] , [symbol] ) did not return any binding that is QoS-equivalent to b. PQDSS<1>( [symbol] , [symbol] , [symbol] ) would return all possible bindings for [symbol] if every call to DomOrEq<1> returned false. If b was not returned itself, there must be at least one fragment W∈NFrags( [symbol] ) such that there is a binding b_{f} for W where b_{f}>w b and b_{f} is Pareto-optimal for W. But then one could use b_{f} to construct a binding for [symbol] which is at least as good as b in every QoS dimension according to Lemma 1. This contradicts our assumptions and proves the theorem.

### 4.2.2. Time and Space Complexity

While A-EXACT offers perfect approximation precision, this comes at a high cost in time and space complexity as shown in the following.

### Lemma 2.

For at least two QoS attributes (A≧2) with non-finite value domains, there are families of workflows and registries such that the size of the Pareto sets grows exponentially in the number of workflow tasks.

Proof: One describes a family of workflows where the Pareto set contains 2^{N} elements. One assumes that one has two negative QoS attributes with at the same time discrete but non-finite value domains (e.g. response time in seconds and monetary cost in cents). This proof easily generalizes to bounded but continuous value domains. Assume a sequence of N simple tasks, numbered from 1 to N. Assume further that two services sᵢ¹,sᵢ²∈ [symbol] are applicable for every task i and that no service is applicable for more than one task. Then one has S=2·N services in the registry and 2^{N} bindings are possible. Now one assigns to service sᵢ⁰ QoS vector (2ⁱ,0) and to service sᵢ¹ QoS vector (0,2ⁱ). Assume that the QoS values of the whole sequential workflow are aggregated as sum of the QoS of the selected services (this is the case for cost and response time). Consider an arbitrary binding b for the workflow. If one exchanges the selected service for any task improving the QoS for one of the two QoS properties, then this necessarily worsens the QoS in the other attribute. Therefore, no other binding can dominate b and b is Pareto-optimal. Since b was chosen arbitrarily, all possible bindings are Pareto-optimal. Also note that different bindings have never equivalent QoS. Therefore, any Pareto set must contain all bindings. Since there are 2^{N} bindings, the size of the Pareto set grows exponentially in the number of workflow tasks.

### Corollary 1.

The worst-case space complexity of any algorithm that returns a Pareto set for all PQDSS problem instances, must be exponential in the number of workflow tasks.

Proof: This is a direct implication of Lemma 2. Since the size of the Pareto set may grow exponentially in the number of workflow tasks, this is a lower bound on the worst-case space complexity of the entire algorithm.

### Corollary 2.

The worst-case time complexity of any algorithm that returns a Pareto set for all PQDSS problem instances, must be exponential in the number of workflow tasks.

Proof: This is a direct implication of Corollary 1, since the space complexity is in general a lower bound for the time complexity.

### 4.2.3. Summary of Analysis

One has shown that A-EXACT offers perfect approximation precision. However, one has proven that no algorithm which returns a complete Pareto set can have polynomial time and space complexity. One must therefore give up on finding the real Pareto-frontier and trade approximation precision for lower space and time complexity. The next section presents our first try to do so.

### 5. Algorithm 2: Heuristic Approximation of Pareto Set

One refines the algorithm from the last section and present algorithm A-HEUR that has polynomial (instead of exponential) time and space complexity in all problem parameters. A-HEUR is a heuristic and cannot give guarantees on approximation precision. The relationship between input and output of the main function is the following:
Input: A PQDSS problem [symbol] =< [symbol] , [symbol] , [symbol] >, a target resolution tr
Output: An approximated Pareto set B for [symbol] , the approximation tends to be better if tr is lower

One presents A-HEUR in Section 5.1 and formally analyze it in Section 5.2.

### 5.1. Description of A-HEUR

FIG. 10 shows the pseudo-code of the main function (PQDSS<2>) and the function that compares QoS vectors (DomOrEq<2>). The input of PQDSS<2> is a PQDSS problem [symbol] =< [symbol] , [symbol] , [symbol] > with a target resolution, tr. Note that both parameters are declared as global. Choosing a higher target resolution tends to increase the approximation precision but also the run time. The output of PQDSS<2> is an approximated Pareto set for [symbol] .

One discusses the internals of PQDSS<2> The function introduces the global variable QR (so one can access them in function DomOrEq<2> without specifying them as parameters) that contains total QoS ranges (see Definition 11) for every workflow fragment. QR is calculated using the auxiliary function calcTQR. One do not explicitly provide pseudo-code for this function but describe informally how the total QoS ranges can be calculated efficiently. Deriving pseudo-code from this description is straight-forward.

The total QoS range for a simple task T can be calculated using (4) for the lower and (5) for the upper bound. One compares the QoS of all services separately for all attributes and respectively keep the minimum as lower and the maximum as upper bound.

$$\begin{matrix}{QR}_{L}^{a} ( T ) = {min}_{s ∈ candidates ( T )} {QoS}^{a} ( s ) & ( 4 ) \\ {QR}_{U}^{a} ( T ) = {max}_{s ∈ candidates ( T )} {QoS}^{a} ( s ) & ( 5 )\end{matrix}$$

Total QoS ranges for a complex workflow W are calculated out of the total QoS ranges of its two fragments <W₁,W₂>=Split(W). If W₂=∈ (W₂ does not contain tasks), one sets QR(W)=QR(W₁). Otherwise, lower bounds are calculated according to (6) and upper bounds according to (7). Note that one uses the fact that all considered aggregation functions are monotone.

QR_{L}(W)=QoSAF(W)(QR_{L}(W₁),QR_{L}(W₂)) (6)

QR_{U}(W)=QoSAF(W)(QR_{U}(W₁),QR_{U}(W₂)) (7)

FIG. 11 illustrates how total QoS ranges are calculated, from the bottom-up.

One discusses the internals of DomOrEq<2>. In contrast to DomOrEq<1>, this function does not compare the original QoS values of the two input vectors but the corresponding QoS levels (see Definition 12). QoS levels are calculated w.r.t. the total QoS range of workflow fragment W and resolution tr. This means that DomOrEq<2> also returns true if two QoS vectors are similar but not entirely equivalent (in this case DomOrEq<1> would return false). Using DomOrEq<2> instead of DomOrEq<2> will therefore tend to filter out more bindings thanInsertPareto<1>. This makes PQDSSrec<2> faster than PQDSSrec<1> since it has to treat less bindings for every fragment of [symbol] . On the other hand PQDSS<2> does not guarantee to return a real (meaning: non-approximated) Pareto set anymore. See FIG. 8B for an illustration of how A-HEUR filters bindings.

### 5.2. Analysis of A-HEUR

### 5.2.1. Space Complexity

The following theorem forms the base for time and space complexity analysis since it gives an upper bound on the number of bindings that are returned by PQDSSrec<2>.

### Lemma 3.

When inserting an arbitrary number of bindings into a previously empty set B using function InsertPareto<2>, B can at no point in time contain more than (tr⁻¹+1)^{A-1} bindings.

Proof: InsertPareto<2> inserts a new binding into the set B only if DomOrEq<2> returns false when comparing the QoS of the new binding pair-wise to the QoS of all bindings in B. DomOrEq<2> compares QoS vectors using QoS levels calculated w.r.t. resolution tr. For every QoS dimension there are tr⁻¹+1 possible QoS levels. Therefore, (tr⁻¹+1)^{A} vectors of QoS levels are possible and at most so many bindings with non-equivalent QoS can be contained in B. One shows that even less bindings can be contained in B that such that no binding dominates another. Consider a subset [symbol] of all but one arbitrary attribute: [symbol] = [symbol] \{a}. Assume two bindings have same QoS levels for all attributes in Ã. Then they must either have the same QoS level for a or one of them is better in a than the other. In both cases, they cannot both be contained in B. So one always has at most (tr⁻¹+1)^{A-1} bindings in B.

Now one can analyze the space complexity of the entire algorithm.

### Theorem 2.

Algorithm A-HEUR has space complexity 0(N·tr^{-A+1}). Proof: The global variable QR requires 0(N) space. N instances of PQDSSrec are invoked and up to N instances can be on the stack at the same time. Within PQDSSrec, the local variable with dominant space requirements is res. Since InsertPareto<2> is used to insert new bindings, res can never contain more than 0(tr^{-A+1}) bindings according to Lemma 3. Elements in res include or consist of bindings with associated QoS vector. How much space is necessary in order to represent them? QoS vectors are in 0(1) space since one treats the number of attributes as a constant. Bindings for simple tasks take only the ID of the used service and therefore 0(1) space. Bindings for complex workflows need 0(N) space if represented as set of mappings. However, the bindings in variable res of some instance of PQDSSrec treating a complex workflow can be represented by pointers to two bindings that were produced by recursive calls (assuming that those bindings remain in memory), so in 0(1) space again. Summing space requirements over all N instances of PQDSSrec, one finally obtains space requirements in 0(N·tr^{-A+1}).□

### 5.2.2. Time Complexity

The following theorem analyzes the time complexity of the auxiliary function InsertPareto<2>.

### Theorem 3.

Inserting a new binding into a set B using InsertPareto<2>(B,W) has time complexity 0(|B|).

Proof: InsertPareto<2> iterates at most two times over all elements in B. The calls to DomOrEq<2> are in 0(1) since one treats the number of attributes as constant. Deleting the current element when iterating over a linked list can be done in 0(1) as well. Therefore, the total time complexity is 0(|B|).

Based on Lemma 3 from the last subsection and Theorem 3, one analyzes the time complexity of A-HEUR.

### Theorem 4.

Algorithm A-HEUR has time complexity 0(N·(S+tr^{-2A+2})·tr^{-A+1}).

Proof: The total QoS ranges for all attributes can be calculated in 0(N·S). One instance of PQDSSrec<2> is executed for every nested workflow fragment of W, therefore N instances. An instance treating a simple workflow generates S bindings that are inserted into a set containing at most tr^{-A+1} bindings according to Lemma 3. Using Theorem 3, an instance of PQDSSrec<2> therefore needs 0(S·tr^{-A+1}) time. An instance of PQDSSrec<2> treating a complex workflow executes two nested for-loops, where the outer loop iterates over all bindings returned for the first fragment and the inner loop over all elements returned for the second fragment. The insertion of a binding can be done in 0(tr^{-A+1}) applying the same reasoning as before. Also, at most 0(tr^{-A+1}) bindings can be returned by any instance of PQDSSrec<2> according to Lemma 3. Therefore an instance of PQDSSrec<2> treating a complex workflow requires 0(tr^{-A+1}·tr^{-2A+2}) time. One obtains the total time complexity by summing over all N instances of PQDSSrec<2>.

### 5.2.3. Approximation Precision

A goal is to conceive an algorithm for PQDSS that scales in problem parameters but provides at the same time guarantees on the approximation precision. The following theorem shows that A-HEUR cannot provide such guarantees and requires further refinement.

### Theorem 5.

For any target resolution tr, there are PQDSS problem instances such that A-HEUR cannot guarantee to return an approximated Pareto set with error lower than

$$e = \frac{1}{tr} - 1 ( close to the theoretical maximum \frac{1}{tr} ) .$$

Proof: One assumes that one optimizes only for one negative QoS attribute, for instance response time. Since one considers only one attribute, one omits the attribute index throughout this proof. Assume that a is calculated as maximum in complex workflow W. Assume further that <W₁,W₂>=Split(W) and that

$${R}_{1} = QR ( {W}_{1} ) = 〈 \frac{1}{r} - \frac{1 , 1}{r} 〉$$

$$and$$

$${R}_{2} = QR ( {W}_{2} ) = 〈 \frac{0 , 1}{r} 〉 .$$

Assume one has a binding b₁ for W₁ with

$$QoS ( {W}_{1} , {b}_{1} ) = \frac{1}{r} - 1 + ε$$

(where ∈ designates an infinitesimally small value) and two bindings b₂ and b₂ for W₂ such that

$${q}_{2} = QoS ( {W}_{2} , {b}_{2} ) = \frac{1}{r} - 1 + ε and$$

$${q}_{2} = QoS ( {W}_{2} , {b}_{3} ) = \frac{1}{r} .$$

Then q₂=_{R}_{₂}_{·tr} q₂ and therefore the call PQDSSrec<2>(W₂,tr) returns only one of the bindings b₂ and b₂ and chooses non-deterministically among them. But if b₂ is not returned, the instance of PQDSS<2> treating W has to use binding b₂ for constructing the complete binding for W. The resulting binding for W might have

$$QoS \frac{1}{r}$$

(therefore minimum QoS level) where

$$QoS \frac{1}{r} - 1 + ε$$

(therefore near maximum QoS level) would have been possible. FIG. 11 illustrates the described situation for tr=3.

### 5.2.4. Summary of Analysis

Algorithm A-HEUR has polynomial time and space complexity in the number of workflow tasks, service candidates, and in the inverse of the target resolution. However, A-HEUR cannot provide any approximation guarantees since it compares the QoS of bindings w.r.t. the total QoS ranges. One will show how to solve this problem in Section 6.

6. Algorithm 3: A Fully Polynomial Time Approximation Scheme for PQDSS

Algorithm A-EXACT returns the real Pareto set but has exponential space and time complexity.

Algorithm A-HEUR has polynomial space and time complexity but does not guarantee any upper bound on the Pareto error of the result.

One refines A-HEUR into algorithm A-FPTAS which nearly combines the advantages of the two algorithms presented before. The relationship between input and output of the main function is the following:
Input: A PQDSS problem [symbol] =< [symbol] , [symbol] , [symbol] >, a target resolution tr
Output: An approximated Pareto set B for [symbol] with bounded Pareto error s.t. Pset₁(B, [symbol] ,tr)

A-FPTAS combines polynomial space and time complexity in number of workflow tasks, services, and in the inverse of the target resolution with guarantees on the approximation precision. It is therefore a fully polynomial time approximation scheme, see reference [8].

One presents A-FPTAS in Section 6.1 and formally analyze the algorithm in Section 6.2.

### Example 12

One illustrates the precision guarantees of A-FPTAS by means of our running example (see FIG. 4B). The figure represents QoS levels (calculated w.r.t. the total range and resolution

$$r = \frac{1}{5} )$$

of the 12 possible bindings. Bindings b₇ and b₈ are Pareto-optimal. A-FPTAS returns if not b₇ itself, then another binding whose QoS levels are not farther away than one grid cell in every direction. Bindings b₈ and b₁₁ satisfy this condition. Considering b₈, the algorithm returns if not b₂ itself then at least b₁ or b₂.

### 6.1. Description of A-FPTAS

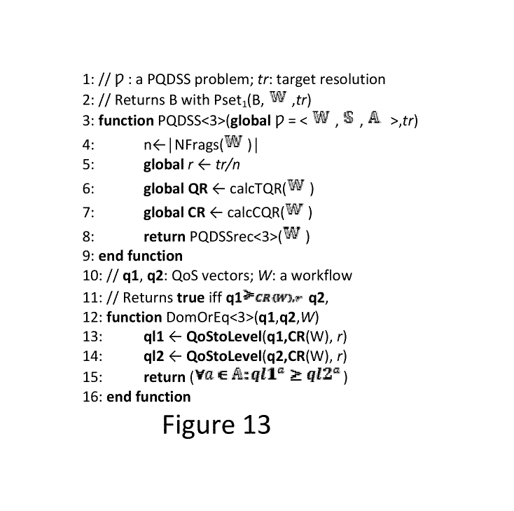

FIG. 13 shows the pseudo-code of the main function (PQDSS<3>) and the function that compares QoS vectors (DomOrEq<3>). The input to PQDSS<3> includes or consists of the PQDSS problem [symbol] =< [symbol] , [symbol] , [symbol] > and the target resolution tr. The output is an approximated Pareto set for [symbol] that has Pareto error at most 1 w.r.t. resolution tr. Choosing a finer target resolution therefore yields a closer approximation.

One explains the internals of PQDSS<3> and highlight differences to PQDSS<2>. The first change in comparison with PQDSS<2> is that the internal resolution r (which is used for comparing QoS vectors) is set finer than the target resolution tr by a factor proportional to the number of workflow fragments in W. One explains the intuition behind this choice while one postpones the formal analysis until Section 6.2. One filters out bindings for every workflow fragment (in the instance of PQDSSrec<3> that treats the corresponding fragment). By doing so one might lose Pareto-optimal bindings for the fragment while keeping only near-optimal ones. Hence one introduces an error that accumulates over all workflow fragments. Therefore, in order to guarantee a fixed upper bound on the Pareto error of the result (1 in our case), one must choose the internal resolution finer, the more workflow fragments one has. PQDSS<3> calculates total QoS ranges for every workflow fragment (line 6.1) in the same way as PQDSS<2> did, using function calcTQR. See Section 5.1 for a detailed description.

Theorem 5 showed that comparing bindings based on their QoS levels calculated w.r.t. total QoS ranges, does not yield approximation guarantees. One introduces critical QoS ranges in order to cope with this problem. PQDSS<3> calculates critical QoS ranges for every workflow fragment in line 7 using function calcCQR. Function DomOrEq<3> compares QoS vectors by scaling them w.r.t. critical ranges. Before one provides formulas for calculating critical ranges, one first gives an intuition why critical ranges are helpful.

### Example 13

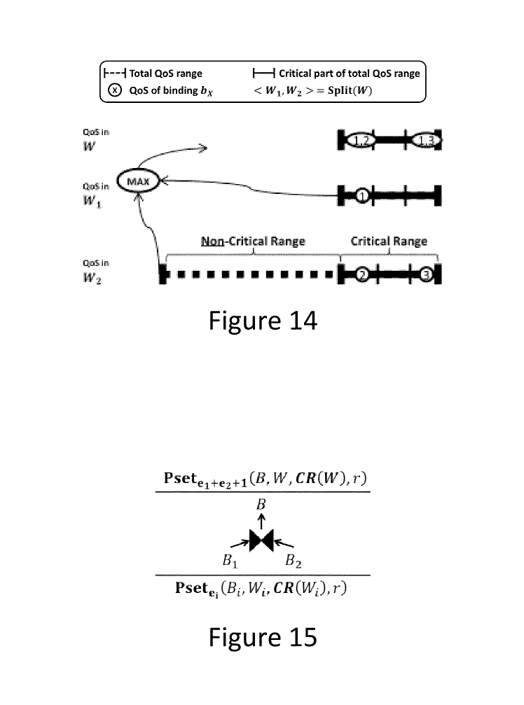

one shows how critical ranges solve the problem described in Theorem 5. FIG. 14 illustrates the situation one describes in the following (compare with FIG. 12). One considers one negative QoS attribute whose QoS value for complex workflow W is aggregated as maximum over the QoS of the fragments W₁ and W₂ (<W₁,W₂>=Split(W)). Assume one has one binding b₁ for W₁ and two bindings, b₂ and b₂, for W₂ where b₂ has better QoS. The QoS level of the combined binding b_{1,2}=b₁∪b₂ for W, calculated w.r.t. the total QoS range of W and resolution

$$r = \frac{1}{3} ,$$

is significantly better than the level of b_{1,2}∪b₁∪b₂. Due to the definition of critical ranges, this implies that the QoS level of b₂⊂b_{1,2}, calculated w.r.t. the critical range of W₂ and resolution r, is significantly better for W₂ than the one of b₂ as well. This guarantees that the call

$$PQDSSrec 〈 3 〉 ( \frac{{W}_{2 , 1}}{3} ) ( unlike PQDSSrec 〈 2 〉 ( \frac{{W}_{2 , 1}}{3} ) )$$

returns binding b₂. Therefore, PQDSSrec<3>(W,⅓) returns b_{1,2}.

FIG. 15 illustrates the important property of critical ranges in general. For i∈{1,2} let Wᵢ the two fragments of W and Bᵢ an approximated Pareto set for Wᵢ. One can combine the bindings for the fragments to form a set B of bindings for W: B={<b₁∪b₂,QoSAF(W)(q₁,q₂)>|<bᵢ,qᵢ>∈Bᵢ, i∈{1,2}}. When calculating w.r.t. critical ranges and some resolution r, the Pareto error of B is bounded by the Pareto errors of the Bᵢ. Formulated differently: When scaling w.r.t. critical ranges, good approximated Pareto sets for workflow fragments can be combined into good approximated Pareto sets for the parent workflow. This distinguishes critical ranges from total QoS ranges and allows PQDSSrec<3> to filter out bindings for every fragment of [symbol] while still giving precision guarantees. Note that one is finally interested in the Pareto error w.r.t. the total QoS ranges of the input workflow [symbol] . However, critical ranges will be defined in a way such that the critical range equals the total range in [symbol] . See FIG. 8C for an illustration of how A-FPTAS filters bindings.

<W₁,W₂>=Split(W);i∈{1,2};a∈

[symbol]

TABLE 3
formulas for calculating critical ranges

| Type | QoSAF^{α}(W [symbol] | | |
|---|---|---|---|
| of α | (q₁ [symbol] q₂) [symbol] | CR_{L}^{α}(Wᵢ) | CR_{U}^{α}(Wᵢ) |
| 1, 2 | (All) | QR_{L}^{α}(Wᵢ) | QR_{U}^{α}(Wᵢ) |
| 3 | min□(q₁, q₂ [symbol] | QR_{L}^{α}(Wᵢ) | min□(QR_{U}^{α}(Wᵢ), |
| | | | CR_{U}^{α}(W)) |
| | qw₁q₁ + qw [symbol] | QR_{L}^{α}(Wᵢ) | [symbol] min [symbol] ( [symbol] QR [symbol] |
| | | | _{↓}U^{↑}α (W_{↓}i), |
| | | | [symbol] QR [symbol] _{↓} [symbol] + ( [symbol] CR [symbol] |
| | | | _{↓}U^{↑}α (W) − |
| | | | [symbol] CR [symbol] _{↓}L^{↑}α (W [symbol] |
| 4 | max□(q₁, q [symbol] | max□(QR_{L}^{α}(Wᵢ), | QR_{U}^{α}(Wᵢ) |
| | | CR_{L}^{α}(W)) | |
| | qw₁q₁ + qw [symbol] | [symbol] max [symbol] ( [symbol] QR [symbol] | QR_{U}^{α}(Wᵢ) |
| | | _{↓}L^{↑}α (W_{↓}i), | |
| | | [symbol] QR [symbol] _{↓} [symbol] − ( [symbol] CR [symbol] | |
| | | _{↓}U^{↑}α (W) − [symbol] CR [symbol] | |
| | | _{↓}L^{↑}α (W [symbol] | |

[symbol]

indicates data missing or illegible when filed

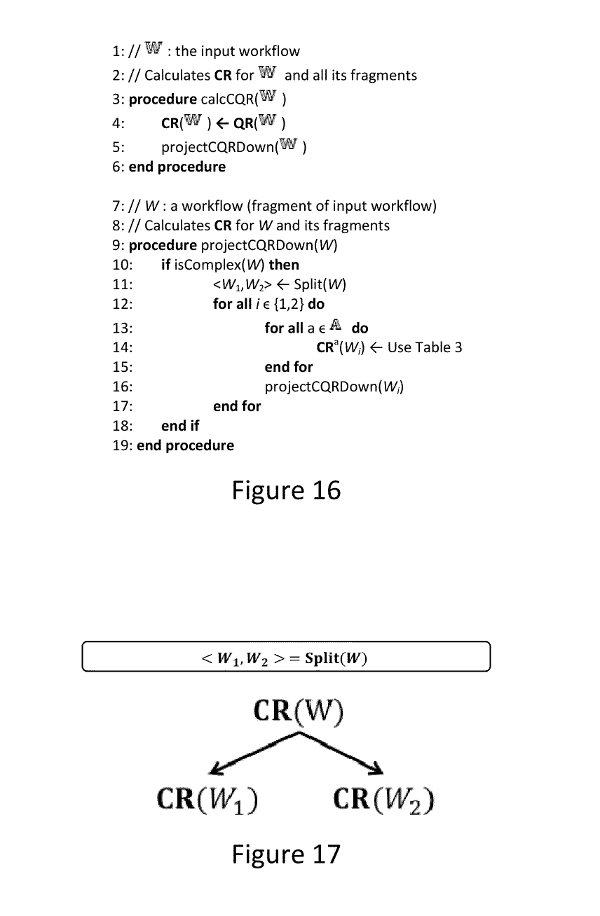

One now discusses procedure calcQCR which calculates critical ranges for all workflow fragments. The pseudo-code of calcCQR and of projectCQRdown (an auxiliary procedure used by calcCQR), is shown in FIG. 16. Procedure calcCQR takes a workflow [symbol] as input and calculates critical ranges for all nested fragments of [symbol] . The critical ranges are saved in the global variable CR. The critical range of [symbol] is equal to the total QoSrange of [symbol] (line 4). Note that calcCQR can therefore only be invoked after total QoS ranges have been calculated. One invokes projectCQRdown in order to calculate critical ranges for all fragments of [symbol] . Procedure projectCQRdown obtains a workflow W as input (which is a fragment of [symbol] ). The goal of projectCQRdown is to calculate critical ranges for the fragments of W (if W is complex) using the critical range for W. Critical ranges are calculated separately for the two fragments of W and for every single attribute a∈ [symbol] . After critical ranges have been calculated for all attributes of fragment W projectCQRdown executes a recursive call to calculate critical ranges for the fragments of W. FIG. 17 illustrates how critical ranges are calculated top-down in the workflow tree.

Procedure projectCQRdown uses the formulas from Table 3 to calculate critical ranges. The formulas that are used for calculating the range for a specific attribute depend on the attribute type. One distinguishes four types of attributes. Table 4 shows how attributes are classified. One classifies according to two criteria:
Value domain, distinguishing the three cases
   i) unitary bounded domain (values within [0,1]),
   ii) bounded domain (values within [0,c] where c is a positive constant), and
   iii) unbounded domain (values within [0,∞]).
Set of allowed aggregation functions, which is always a subset of the aggregation functions minimum (min□), maximum (max□), weighted sum

$$( {\sum }^{} ) ,$$

and product

$$( {\sum }^{} ) .$$

### Example 14

### Attribute Classification

Attribute reliability is a probability and has value domain [0,1]. It uses the product aggregation for sequence and parallel execution, while the worst-case reliability for a choice construct is calculated as minimum over the reliabilities of the branches. Since the product aggregation is used, the attribute must be of type 1. Attribute response time has a priori (without considering a specific workflow) an unbounded value domain. It uses the sum aggregation for sequential, and the maximum for parallel execution and for calculating the worst-case execution time of a choice construct. Therefore it has attribute type 4.

TABLE 4
Classification of QoS Attributes

| | Value | Aggregation | |
|---|---|---|---|
| Type | Domain | Functions | Examples |
| 1 | [0, 1] | min, max Σ, Π | Reliability, |
| | | | availability |
| 2 | [0, c] | min max, Σ | Reputation |
| 3 | [0, ∞] | $min □ □ , {\sum }_{□}^{ } □$ | Throughput |
| 4 | [0, ∞] | $max □ □ , {\sum }_{□}^{ } □$ | Time, cost |

Dividing attributes into classes is necessary since one cannot construct critical ranges with the aforementioned properties for all combinations of aggregation functions and value domains. Assume for instance one allows an unbounded value domain together with maximum, minimum, and sum aggregation for some attribute a. By the combination of minimum and maximum aggregation one might obtain a critical range for some workflow W∈ [symbol] which is included in the total QoS range of W (QR_{L}^{a}(W)<CR_{L}^{a}(W)<CR_{U}^{a}(W)<QR_{U}^{a}(W)). If W is complex and a is aggregated as sum in W, one cannot provide critical ranges for the fragments of W anymore. Fortunately, the given attribute classes cover all of the most commonly used QoS attributes in PQDSS and UQDSS as the examples in Table 4 show.

### Example 15

### Calculating Critical Ranges

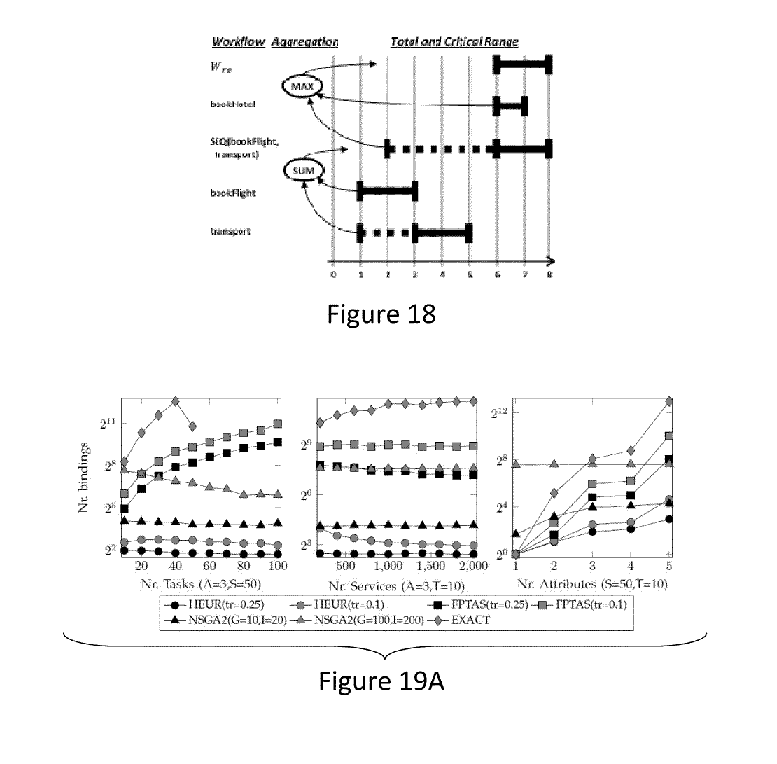

FIG. 18 shows total and critical ranges for the response time attribute and all fragments of our running example workflow (see FIG. 2A). The critical range for reliability always corresponds to the total QoS range (which is the interval [0,1]).

### 6.2. Analysis of A-FPTAS

One analyzes space and time complexity in Section 6.2.1, and approximation precision in Section 6.2.2. One uses the notations and assumptions outlined in Section 2.4. By

$$r = \frac{tr}{N}$$

with N=|NFrags( [symbol] )| one denotes the internal resolution. One summarizes the results in Section 6.2.3.

### 6.2.1. Space and Time Complexity

One omits the proofs for the following theorems since they are very similar to the proofs in Sections 5.2.1 and 5.2.2.

### Theorem 6.

Algorithm A-FPTAS has space complexity

0(N·r^{-A+1})

### Theorem 7.

Algorithm A-FPTAS has time complexity

0(N·(S+r^{-A+1})·r^{-A+1})

### 6.2.2. Approximation Precision

The following theorem shows that PQDSSrec<3> can construct a good approximation of the Pareto set for a workflow W, having good approximations of the Pareto sets for the fragments of W.

### Theorem 8.

Let W a complex workflow, <W₁,W₂>=Split(W). Denote by Bᵢ the results of the calls PQDSSrec<3>(Wᵢ,r) for i∈{1,2} and by B the result of the call PQDSSrec<3>(W,r). Then ∀i∈{1,2}:Psetₑ_{ᵢ}(Bᵢ,WᵢCR(Wᵢ),r) implies Psetₑ_{₁}₊ₑ_{₂}₊₁(B,W,CR(W),r).

The proof of Theorem 8 is lengthy and can be found in Appendix A.

### Theorem 9.

Let W a workflow with N nested fragments. The call PQDSSrec<3>(W,r) returns a set B such that Pset_{N-1}(B,W,CR(W),r).

Proof One proves the theorem by induction over the structure of W. If W is a simple task (induction start), PQDSSrec<3> generates all possible bindings and discards bindings only if their QoS levels are equivalent or dominated by other bindings. Therefore, the function returns a set B where Psetₑ(B,W,CR(W),r). One has N=1>0 and so the theorem holds. If W is a complex task with <W₁,W₂>=Split(W), one assumes that the theorem has already been proven for the fragments W₁ and W₂. This means that the calls PQDSSrec<=3>(Wᵢ,r) for i∈{1,2} returned sets Bᵢ such that PSetₑ_{ᵢ}(Bᵢ,Wᵢ,CR(Wᵢ),r) where eᵢ+1 denotes the number of nested fragments in Wᵢ. According to Theorem 8 this implies that PQDSSrec<3>(W,r) returns B with Psetₑ_{₁}₊ₑ_{₂}₊₁(B,W,CR(W),r). Since W has N=e₁+2 nested fragments if W₂ contains no simple tasks, and N=e₁+e₂+4 nested fragments if W₂ nests simple tasks, Theorem 9 holds again in every case.□

In Appendix B, one proves that the error bounds from Theorem 9 are tight, e.g. there are worst cases where the Pareto error reaches the specified bound.

### Theorem 10.

Algorithm A-FPTAS returns a 1-approximated Pareto set for a workflow [symbol] w.r.t. the target resolution tr.

Proof PQDSS<3>( [symbol] , [symbol] , [symbol] ,tr) returns the result of the call PQDSSrec<3>( [symbol] ,r) which one denotes by B. Let N the number of nested fragments in W. One has

$$r = \frac{tr}{N}$$

and Pset_{N-1}(B,W,r) (using Theorem 9 and the fact that the critical QoS range for W equals the total QoS range for W). This implies Pset₁(B,W,tr) since resolution tr is N times more coarse-grained than r.□

### 6.2.3. Summary of Analysis

Our analysis shows that A-FPTAS has polynomial space and time complexity while it offers formal guarantees on approximation precision. It is therefore a fully polynomial time approximation scheme.

### 7. Experimental Evaluation

One evaluates the proposed algorithms experimentally and compare their performance with competing approaches. The main finding is that A-FPTAS (see Section 6) realizes an attractive trade-off between efficiency and precision. Section 7.1 explains the details of our experimental setup, and Section 7.2 presents our experimental results in detail.

### 7.1. Experimental Design

This subsection sets the stage for the experimental evaluation.

### 7.1.1. Hardware and Software Platform

Our measurements were collected on a Sun Fire X4450 server equipped with four Intel Xeon E7340 quad-core CPUs (2.4 GHz) and 16 GB RAM. Our measurement machine runs Ubuntu server 64 bit 11.04 (kernel 2.6.38-12). All our algorithms are implemented in pure Java and are single-threaded. One executed them with Oracle's Java HotSpot 64-Bit Server VM 1.6.0_{—}29 with default heap size and default garbage collector. In other words, the algorithms described herein, including the illustrative pseudo-code provided in the drawings, can be implemented as instructions. These instructions may be stored on a non-transitory computer readable storage medium (such as a hard disk drive, CD, DVD, cloud computing storage area, memory, or the like). They then may be executed or interpreted with the aid of processing resources (including, for example, one or more suitably configured processors and a memory), e.g., to perform method steps similar to those discussed herein and/or corresponding to the general instructions/algorithms described in this application. As will be appreciated, components of the algorithms may be broken down into software, hardware, and/or firmware program modules or the like and, with the aid of processing resources, may be performed in connection with a computer system.

The output from such programs and/or program modules may be output to a display. Of course, that output may be used to select a service candidate automatically or based on user input, etc. That select service candidate may be automatically incorporated into the workflow or based on further user input, etc.

It will be appreciated that the example hardware and software platforms discussed herein and that the exemplary techniques described herein may be implemented using any suitable combination of hardware, software, firmware, and/or the like, regardless of the programming language(s) in which they are implemented.

### 7.1.2. Evaluated Algorithms

A contribution of this application is algorithm A-FPTAS, presented in Section 6. One compares A-FPTAS with A-EXACT, presented in Section 4, and A-HEUR, presented in Section 5. In addition, one compares our algorithms with the Non-dominated Sort Genetic Algorithm II see reference[12], A-NSGA2 in the following, for multi-criteria optimization. A-NSGA2 simulates the evolution of a population of individuals over several generations. Individuals represent bindings in our context, and their genes correspond to service selections for specific tasks. The probability with which an individual in generation t can pass on part of its genes to generation t+1 is inversely proportional to the number of individuals by which it is dominated in generation t (an individual i₁ dominates an individual i₂ if the binding represented by i₁ dominates the binding represented by i₂). In addition, A-NSGA2 takes measures to obtain a representative coverage of the full Pareto set. Claro et al., see reference [6] proposed A-NSGA2 for PQDSS which is the reason why one selected it in our comparison. Our workflow and attribute models are slightly more general than in the approach by Claro et al. In addition, one was not able to find references to the actual implementation and therefore used the JNSGA II Java library² for our implementation (so all compared algorithms are implemented in Java),Important parameters for the performance of NSGA2 are the number of simulated generations and the number of individuals per generation. One considers different parameter settings for our experimental evaluation. For all other parameters (such as mutation probability) one used the same settings as Claro et al. ²http://sourceforge.net/projects/jnsga2/randomly

### 7.1.3. Test Case Design and Generation

One test case includes or consists of a set of QoS attributes, a workflow, and a set of service candidates for every workflow task. One describes the difficulty of test cases using three parameters: The number of attributes, A, the number of simple tasks within the workflow, T, and the number of service candidates per simple task, (one assumes that every task is associated with the same number of service candidates).

One generated workflows with a specific number T of simple tasks as follows. First, one randomly generated a tree with T leafs. Second, one randomly marked the inner nodes by one of the control flow constructs sequential execution, parallel execution, or choice. Third, one assigned simple workflow tasks to one out of 50 functional categories. One generated S service entries per functional category as follows. For most test series, one used QoS measurements of real Web services taken from the QWS dataset, see reference [13]. This data set contains—among others—average values for the attributes response time, availability, throughput, successability, and reliability. In order to generate test cases with a specific number of attributes A≦5, one used the first A attributes in the order they were just mentioned. For every functional category, one randomly selected S services out of the total 2507 services of the QWS data set. The same service may be selected for several functional categories. One did not use this data set for a test series where one increases the number of service candidates up to 2000 services (having nearly the same available services for every task would have biased our results). For this test series one generates service QoS randomly in the interval [0,1] with uniform distribution. In general, one used a uniform probability distribution for all random choices.

### 7.1.4. Evaluation Criteria and Methodology

One compares algorithms w.r.t. the three criteria i) number of returned bindings, ii) run time in milliseconds, and iii) approximation precision measured as Pareto error (see Definition 15,) of the returned set.

### Example 16

One illustrates how the Pareto error is calculated (for resolution

$$r = \frac{1}{5} ) .$$

Consider FIG. 4B). The figure represents the QoS levels of 12 example bindings, where the Pareto set is formed by the bindings b₇ and b₂. Assume one of the evaluated algorithms returns bindings b₁₁ and b₅. So, for the Pareto-optimal binding b₇ a binding (b₁₁) is returned which is not worse by more than one QoS level in every QoS dimension. For the Pareto-optimal binding b₂ the nearest returned binding is b₅ which is 2 QoS levels worse in one of the dimensions (response time). The Pareto error is defined by the part of the Pareto set where the approximation is worst, therefore the Pareto error is 2.

Calculating real Pareto sets was computationally not feasible for all test cases. For some of the test cases, one therefore calculates the Pareto error assuming that A-FPTAS with target resolution tr=01 returned the real Pareto set and comparing sets returned by other algorithms with that. Because of the precision guarantees of A-FPTAS, this approximates the real Pareto error w.r.t. resolution 0.1 with precision±1. During the presentation of results, one will specify where which comparison was used.

One generated three series of test cases, where every series studies the sensitivity of the algorithms w.r.t. one of the three parameters A, T, and S. Every series contains test cases that differ only in one of the three parameters while the other two remain constant (e.g. T, the number of simple tasks is varied while S and A remain constant). For every parameter setting within a series (meaning: a fixed value assignment for the three parameters, e.g. A=3, T=50, S=100), one generated 100 test cases and report arithmetic average values for all measured criteria.

One specified a timeout of 900 seconds per test case. If an algorithm exceeds that threshold, its execution is interrupted, the run time is registered with 900 seconds and the timeout is reported.

### 7.2. Presentation of Results

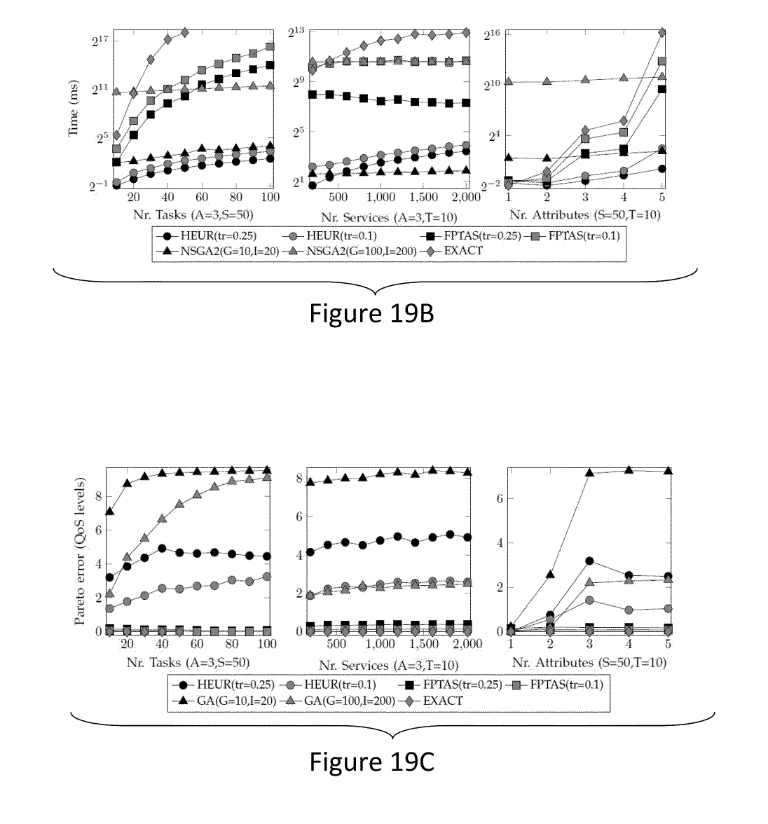

FIGS. 19A-19C show experimental results. In the legend, the same names for the algorithms are used that were used in the text, except that the suffix A- is omitted for better readability. Algorithms are evaluated with specific configurations, denoted in brackets behind the algorithm name, using the abbreviations tr (target resolution) for A-HEUR and A-FPTAS, and G (number of generations) and I (number of individuals per population) for A-NSGA2. Note that a logarithmic scale is used for FIGS. 19A and 19B, while a linear scale is used for FIG. 19C.

### 7.2.1. Timeouts

Comparing the number of timeouts for specific test cases already yields a coarse-grained picture of the relative performance of different algorithms. During experiments, algorithm A-EXACT was the only one to incur timeouts when increasing the number of tasks. More precisely, there were 4 timeouts for N=40, and 28 for N-50 out of 100 test cases respectively.

### 7.2.2. Number of Returned Solutions

FIG. 19A shows the average number of bindings returned by the different methods. Increasing the number of tasks, there were 28 timeouts out of 100 test cases for A-EXACT and 50 tasks (4 timeouts for 40 tasks). A-FPTAS was not executed on instances with higher number of tasks. The number of returned bindings increases for A-EXACT (one explains the decrease from 40 to 50 tasks by the timeouts since instances with higher number of Pareto optimal solutions correlate often with higher run time) and A-FPTAS while the number decreases for A-NSGA2 and (slightly) for A-HEUR. The number of possible bindings grows exponentially in the number of workflow tasks. This explains the increasing number of returned bindings for A-EXACT and A-FPTAS. However, the size of the search space (which includes or consists of the possible bindings) grows exponentially as well and it gets more and more difficult to find Pareto-optimal bindings within it. This explains the shrinking number of returned bindings for the heuristic methods. Comparing different configurations of the same algorithm, instances of A-FPTAS and A-HEUR return more bindings if a finer target resolution is chosen. Instances of A-NSGA2 return more bindings if the number of individuals (an upper bound on the number of returned bindings) is increased. Note that the number of returned bindings for A-EXACT is significantly higher than the ones of the other algorithms.

Increasing the number of service candidates per task, A-EXACT tends to return more bindings, while the numbers remain constant for most algorithms and slightly decrease for A-HEUR. Note that for A-EXACT the number of returned bindings grows faster when increasing the number of tasks than when increasing the number of service candidates. This can be explained by the fact that the number of possible bindings grows exponentially in number of workflow tasks but polynomially in number of service candidates per task. Again, the number of bindings returned by A-EXACT is significantly higher than for the other algorithms.

Increasing the number of attributes, strong growth is seen for the number of returned bindings for all algorithms except for A-NSGA2 where the number converges towards an upper bound. Note that increasing the number of attributes does not increase the number of possible bindings. However, it increases the chances that a binding is not dominated by another binding. Therefore, the expected number of Pareto-optimal bindings does increase, The reason that the number of bindings converges for A-NSGA2 is due to the fact that the maximum number of returned bindings (equal to the number of individuals) is reached quickly for both instances of A-NSGA2. Still, A-EXACT returns more bindings than all other algorithms.

### 7.2.3. Run Time

FIG. 19B shows the average run time for the different algorithms. The run time strongly correlates with the number of returned bindings since generating more bindings takes more time. While discussing FIG. 19B, one will therefore focus on outlining and explaining differences between the tendencies for time and number of bindings. Increasing the number of tasks, the run time increases for all algorithms. Note in particular that the run time for the two heuristic algorithms A-NSGA2 and A-HEUR increases even if they return less and less bindings. For A-NSGA2, the number of tasks corresponds to the number of genes that have to be treated in every iteration. For A-HEUR, more instances of the function PQDSSrec are invoked if the workflow has more tasks. Note also that the run time of A-EXACT does not decrease comparing the average for 40 and 50 tasks. The reason is that one counts the default value of 900 seconds for timeouts when calculating run time averages (this default value is a lower bound on the real value) while one does not count timeouts when calculating averages for the number of returned bindings. The difference in run time between A-EXACT and A-FPTAS is significant: It takes A-EXACT more than three times longer to treat a search space containing 50⁵⁰ possible bindings (50 tasks, 50 service candidates per task) than it takes A-FPTAS with resolution tr=0.1 to treat a search space containing 50¹⁰⁰ bindings (100 tasks, 50 candidates). When not using timeouts, the difference could even be more significant in favor of A-FPTAS.

Increasing the number of service candidates per task, the observed developments in terms of run time are mostly consistent with the ones for number of returned bindings. An exception is the run time for A-HEUR which increases in the number of service candidates. This seems natural since increasing the number of service candidates leads to more bindings that need to be examined. Increasing the number of attributes, the observed tendencies for run time are consistent with the ones observed for number of returned bindings.

### 7.2.4. Approximation Quality

FIG. 19C shows the average Pareto error for the different algorithms. Increasing the number of tasks, one calculates the real Pareto error (by comparison with the set returned by A-EXACT) only until 50 tasks. For more than 50 tasks, one calculates the Pareto error by comparing the set of returned bindings of an algorithm with the set returned by A-FPTAS with resolution tr=0.1. This means that the real Pareto error is approximated with a margin of 1 QoS level. The reason for this procedure is that A-EXACT takes too much time for calculating the real Pareto set for workflows with more than 50 tasks. The Pareto error increases for all algorithms. In particular for the two instances of A-NSGA2, the Pareto error nearly reaches the theoretical maximum for 100 tasks. This is natural since the search space size increases and it becomes harder to find a representative set of near-optimal bindings. The Pareto error for A-EXACT is equal to 0, the one of A-FPTAS very close to 0. Comparing the Pareto error for the two heuristic algorithms A-HEUR and A-NSGA2, one notes that A-HEUR performs significantly better while its run time was lower.

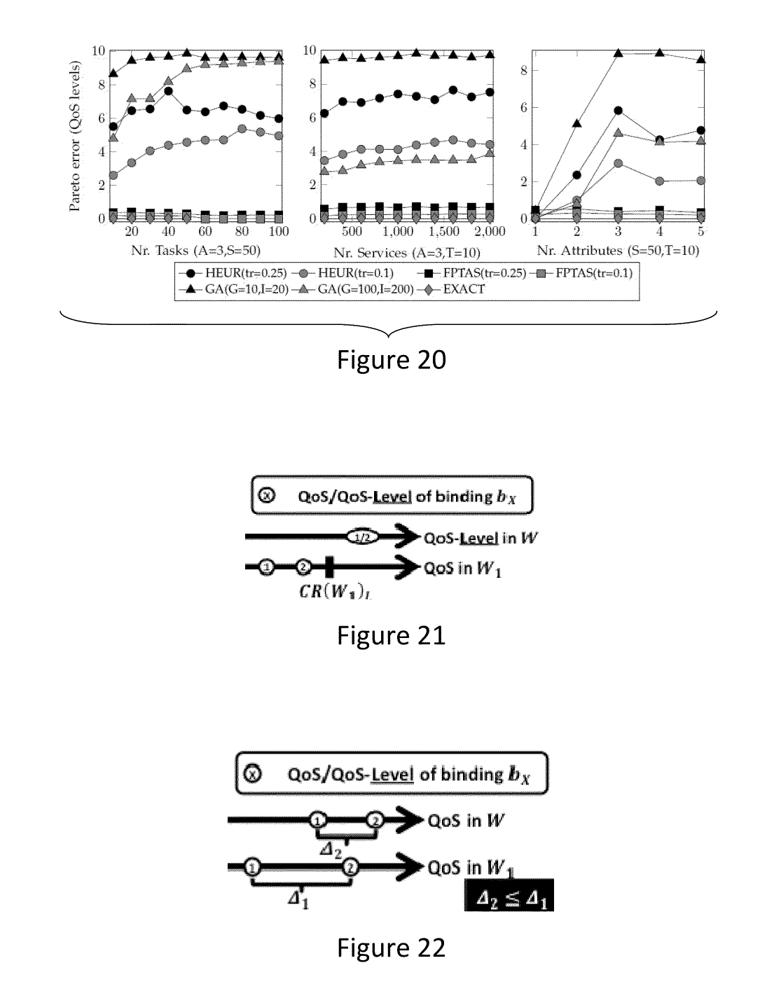

Increasing the number of service candidates per task, one also observes an increase in the Pareto error. The growth is slower than when increasing the number of tasks. This is consistent with the growth of the search space size which is also slower when increasing the number of services (polynomial) than when increasing the number of tasks (exponential). Increasing the number of attributes, one sees an increase in the Pareto error, too. This concerns in particular A-NSGA2 with 20 individuals. Note that this algorithm returns in average almost the maximum possible number of 20 bindings for the case of 5 attributes. It seems that it is not hard to find Pareto-optimal bindings (using 5 attributes, a higher percentage of bindings will be Pareto-optimal than when using 1 attribute) but rather to cover the Pareto set in a representative manner with so few bindings. Again, the Pareto error of A-EXACT is 0 and the one of A-FPTAS close to 0. FIG. 20 shows for every parameter setting the maximum Pareto error that one observed over the 100 test cases. The tendencies are similar to the averages. One notes in particular that the maximum error of A-FPTAS always is significantly below the guaranteed bound, the guarantees hold therefore. The Pareto error of A-HEUR is however often higher than 1 QoS level w.r.t. the target resolution. This shows that the problems outlined in Section 5.2.3 occur in praxis.

8. Comparison with Related Work

Related work is categorized into approaches that maximize a given utility function (Section 8.1) and approaches that find a set of (near-)Pareto-optimal bindings (Section 8.2). In Section 8.3, the work is positioned in this context. One will compare approaches according to the criteria expressiveness of model, ii) run time, and iii) optimality. Speaking of polynomial time complexity in the following, one means polynomial in the number of services and workflow tasks.

### 8.1. Utility-Based Quality-Driven Service Selection

Several approaches to UQDSS, see references [9, 10 and 14], are based on Integer Linear Programming (ILP). The UQDSS problem is transformed into an ILP problem which is then solved by specialized ILP solver software. As the name suggests, ILP problems are defined by a set of variables, a set of linear constraints, and a linear utility function. Zeng et al., see reference [9], and Aggarwal et al., see reference [14], were among the first to propose this general approach, while Ardagna and Pernici, see reference [10], proposed several extensions that allow to consider richer workflow and service models. A principal restriction of this approach is that all problem constraints must be linear. However, the referenced algorithms cover the most common workflow constructs and attributes using various transformations (e.g. working with the logarithm instead of the raw attribute value for attributes with product aggregation such as reliability, see reference [9]). ILP solvers guarantee to find the optimal solution according to the specified utility function. However, the algorithms solve NP-hard problems optimally and have therefore exponential time complexity. Constraint Optimization Programming (COP) offers a more general framework than ILP, since constraints do not have to be linear anymore. Hassine et al., see reference [15], model the UQDSS problem as a COP problem. As for ILP, this approach can guarantee to find an optimal solution but has exponential time complexity in this case.

Genetic Algorithms (GA) were proposed for UQDSS by Canfora et al., see reference [16]. Modeling UQDSS as a GA problem, individuals correspond to bindings, genes to workflow tasks and gene values to services. Comparing with ILP, this approach does not impose any restrictions on the model for utility functions and problem constraints. In addition, GAs have polynomial time complexity and the benchmarks presented by Canfora et al. show that GAs are faster than ILP-based approaches for problems starting from a certain size. However, GAs are of heuristic nature and can therefore not give any approximation guarantees. Gao et al., see references [17, 18] propose a GA that exploits a tree representation of workflows (similar to the one used by our algorithms) to avoid redundant computations when calculating QoS values. This leads to increased efficiency comparing with the approach by Canfora et al. Tang et Ai, see references [19, 20], present another GA for UQDSS that is particularly adapted to handle dependency constraints between service selections for different tasks efficiently.

Various other heuristic approaches have been proposed for UQDSS. Jaeger et al., see reference [21], point out similarities between UQDSS and knapsack and project scheduling problems. They adapt heuristics from these problems to UQDSS and evaluate the performance. Yu et al., see reference [22,23], formalize UQDSS as multi-choice multi-dimensional knapsack problem and as multi-constraint optimal path problem and propose several heuristic algorithms. Berbner et al., see reference [24], first solve a non NP-hard relaxation of the UQDSS ILP problem and use the solution as starting point for further refinements. Comes et al., see reference [11], describe two heuristic algorithms that can be tuned via different parameters, trading result quality for lower run time.

Some authors treat significantly simplified versions of the UQDSS problem for which polynomial time algorithms with approximation guarantees can be found. Bonatti and Festa, see reference [25], model workflows as sets of service invocations. They present among others one algorithm that guarantees to approximate the optimal cost by a ratio of 1.52 and runs in quasi-linear time. They claim however, that this algorithm seems too slow for real-time service selection over large workflows and offer sets. Klein et al., see reference [26], relax the UQDSS problem by searching for an optimal probabilistic selection policy instead of a binding. The resulting problem can be formalized using Linear Programming (instead of ILP) and can be solved in polynomial time. However, their approach cannot guarantee that global constraints are respected for any specific execution.

### 8.2. Pareto Quality-Driven Service Selection

Different heuristic algorithms have been proposed for PQDSS. Claro et al., see reference [8], use a specific GA for multi-criteria optimization and apply it to PQDSS. This GA in is compared with in the experimental evaluation. Wada et al., see reference [27], use a GA as well. Jiuxin et al., see reference [28], use particle swarm optimization for PQDSS. They claim lower time complexity than the GA but point out that solution quality may fluctuate due to the randomness of the approach. Kousalya et al., see reference [29], propose to use multi-objective bees algorithms for PQDSS. Those are population-based, heuristic search algorithms that mimic the behavior of honey bees. Common to all those approaches is that they run in polynomial time but cannot guarantee approximation quality.

An alternative branch of work aims at calculating the explicit, real Pareto frontier in PQDSS. Since the size of the Pareto frontier may grow exponentially in the number of workflow tasks, such algorithms can never have polynomial time complexity. Yu and Bouguettaya, see references [7, 30], present algorithms for calculating all Pareto-optimal bindings (the service skyline in their terminology) in a bottom-up fashion. The One-Pass algorithm (OFA) enumerates bindings and prunes dominated ones, optimizing the order of enumeration to prune as early as possible. The Dual Progressive Algorithm (DPA) progressively reports Pareto-optimal bindings, so partial results can already be retrieved before the algorithm terminates. The Bottom-Up Algorithm (BUA) improves the efficiency of DPA by calculating the Pareto set for larger and larger parts of the workflow. In additional work, see reference [31], Yu and Bouguettaya generalize the PQDSS problem to cover uncertainty w.r.t. provider QoS.

### 8.3. Positioning of the Exemplary Techniques Presented Herein

One compares existing work in particular with the A-FPTAS algorithm presented herein. This is a PQDSS algorithm, however it can be easily used for UQDSS as well (given a utility function, iterate over the result set of A-FPTAS to select the binding with maximum utility) and the precision guarantees for PQDSS translate to precision guarantees for UQDSS if linear utility functions are used. A-FPTAS is therefore compared with related work in PQDSS and UQDSS at the same time.

Most existing approaches in PQDSS and UQDSS can be classified into one of two categories: heuristic algorithms (such as GAs) that cannot provide any precision guarantees, or exact algorithms that return all Pareto-optimal bindings (in PQDSS) or solve NP-hard optimization problems (in UQDSS) and suffer therefore from exponential run time complexity. Approaches that combine precision guarantees with polynomial run time do only exist for UQDSS and are based on non-standard or significantly simplified problem models. To the best of our knowledge, A-FPTAS is the first algorithm to combine polynomial time complexity with precision guarantees for PQDSS, and the first to combine polynomial time complexity with precision guarantees for UQDSS while supporting complex workflow models (workflow constructs such as sequence, parallel execution, and choice in conjunction with diverse QoS attributes such as run time, cost, reliability, and reputation).

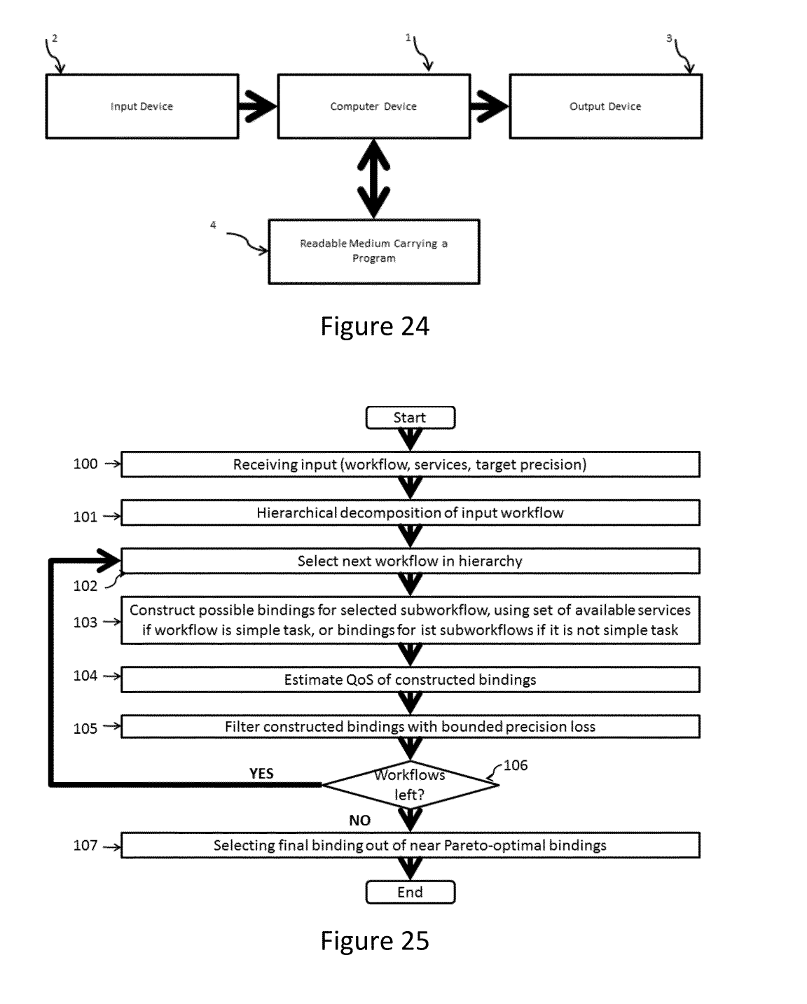

FIG. 24 illustrates a block-diagram of a device suitable to carry out the method of the present invention. As described herein, the device comprises at least input devices 2 such as a keyboard, USB port or other equivalent connection port (hardware or wireless), or even a network, output devices 3 such as a screen, USB or other ports, or a network and to a readable medium 4 carrying a program, wherein said computer device and said program receives an input workflow description comprising the set of variables, the set of alternative values for each of said variables, the function relating said variables in said workflow with cost and/or quality properties of said workflow, and the minimum precision. The program then
a) Associates with said input workflow a hierarchical decomposition comprising at least a first node and a second node wherein said first node is the parent of said second node and both nodes are associated with workflow descriptions such that all variables comprised in the workflow description associated with said second node are also comprised in the workflow description associated with said first node;
b) Computes for the second node a set of bindings, each binding associating each variable of the workflow associated with said second node with a value;
c) Computes for the first node a set of bindings, each binding associating each variable of the workflow associated with said first node with a value, wherein each binding computed for said first node is constructed out of a binding computed for said second node such that said binding computed for said first node assigns all variables comprised in the workflow associated with said second node to the same values as the binding for said second node it was constructed from;
d) Associates with each of the bindings computed for said first node the quality and/or cost properties according to said function relating variables with cost and/or quality properties of said workflow;
e) Filters the set of bindings associated with the first node to possibly reduce its size, said filtering being executed in a way such that the minimum precision requirements are respected.

The computer device 1 may be standalone device (for example such as a PC) or a network of devices or a combination thereof. It therefore may include at least one processor, a memory, etc., suitable for implementing instructions corresponding to the program.

The readable medium 4 may be a hardware and potentially non-transitory element, such a disk or a memory means or a network for example the internet or a cloud or a combination thereof.

The connection and communication between the elements of the device may be via wired or wireless, optical etc.: any suitable mean with appropriate communication protocol or a combination thereof.

In the following, one describes an embodiment of the invention. The following description is representative and not intended to limit the scope of our claims. In particular, the following description of a specific embodiment relates to the application scenario of quality-driven Web service selection (QDWSS). It should be understood that one does not restrict the scope of our claims to this application scenario.

In QDWSS, workflows are described as set of tasks with a defined control flow among them. Tasks are associated with sets of services that can accomplish those tasks. Those services differ by their non-functional cost and/or quality properties that are in this context referred to as Quality-of-Service (QoS) properties. Before a workflow can be executed, its task is bound to concrete services out of the set of available services. A binding for a workflow maps its tasks to services and allows to execute the workflow. The QoS properties of bindings depend on the selected services. The goal of QDWSS is to find a binding whose QoS are optimal for one specific user. In order to select the best binding, it is the most natural for users to take this decision after having obtained an overview of the range of possible tradeoffs between possibly conflicting QoS properties (e.g. in the form of a visual representation as a curve that shows how time can be improved by investing more money through the selection of higher-priced but faster services). Therefore, a computer-implemented method is required that is able to find a representative set for visualization and selection.

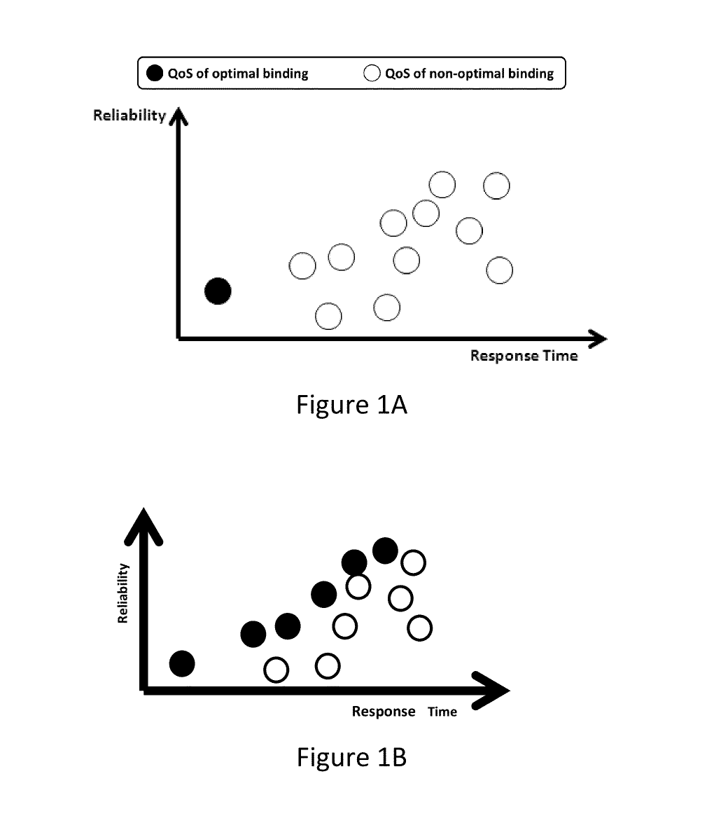

Note that one can restrict our search to Pareto-optimal bindings. A binding is Pareto-optimal, if no other binding exists that is better or equivalent for all considered QoS properties and better in at least one. FIG. 1B represents the QoS of several bindings as dots within a two-dimensional QoS space (reliability and response time). All Pareto-optimal bindings are marked as black dots while dominated bindings are marked as white dots. Finding all Pareto-optimal bindings might however be prohibitively expensive. The goal is therefore to approximate the set of Pareto-optimal bindings by a representative set of near-Pareto-optimal bindings. One describes a computer-implemented method that allows users to choose an approximation precision and approximates the real Pareto set of bindings with that precision.

FIG. 25 shows a high-level flow diagram depicting the main steps of a typical embodiment. At 100, input data is received describing the QDWSS problem instance to solve. The input data includes in particular
a) a description of the workflow to optimize, which is in this application domain often described as graph wherein nodes represent atomic tasks and edges represent control flow between those tasks;
b) for every atomic task a set of available services that could accomplish this task, and statistics about the QoS properties of those services;
c) a specification of a target precision that the result must at least satisfy.

At 101, a hierarchical decomposition of the input workflow is calculated. The elements of the resulting hierarchy are therefore workflows that are parts of the input workflow. Two workflows in said hierarchy are linked if one workflow is a part of the other workflow. Said hierarchy can for instance be represented in the form of a tree, wherein nodes correspond to workflows and a node A is contained within the sub-tree of a node B, if and only if the workflow associated with B is part of the workflow associated with A. One therefore uses in the following the terms child workflow respective parent workflow to describe relationships between workflows in that hierarchy.

Note that 102 is the entry point of a loop between 102 and 106. Therefore, steps 102 to 106 might be executed several times. At 102, one of the workflows in the hierarchy is selected that satisfies the following two conditions:
a) the workflow was not selected in previous iterations;
b) all its child workflows (if any) have already been selected in previous iterations.

This implies in particular that in the first iteration only a workflow can be selected that has no children in said hierarchy. Referring to the tree representation of the hierarchy, this means that nodes are selected in bottom-up order.

At 103, a set of bindings for said selected workflow is constructed. If said selected workflow does not have any children in the hierarchy, said set of bindings is generated directly from the input received at 100. The selected workflow might for instance represent an atomic task within the input workflow. In this case, the possible bindings correspond to the applicable services. If said selected workflow does have children in the hierarchy, possible bindings are constructed by combining bindings for the child workflows that have been retained from previous iterations. Note that it is this property of our method which makes it necessary at 102 to select only workflow whose children have all been selected and treated before.

At 104, QoS properties of said constructed bindings for said selected workflow are estimated. If said selected workflow is an atomic task the QoS estimates from the bindings follow directly from the QoS properties of the selected services. If said selected workflow has children in said hierarchy, its QoS properties might be estimated from QoS properties estimated for the bindings for the child workflows out of which it was constructed.

At 105, some of the constructed bindings might be discarded by a filtering operation while others will be retained for use in following steps. The goal of the filtering operation is to increase the efficiency of the following steps by reducing the number of bindings that need to be considered (for instance for the construction of new bindings for the parent workflow). While discarding bindings increases efficiency, it is dangerous because it might prevent us from constructing optimal bindings for the parent workflow and finally for the input workflow. One must filter in a way that guarantees to finally meet the precision requirements defined in the input at 100. Which filtering operations are appropriate, depends in general on the metric that is applied to measure precision and to define said minimum precision requirements. One will later discuss a specific measure of precision together with an appropriate filtering method for illustration.

After having filtered bindings, it is decided at 106 whether additional iterations of the loop starting at 102 and ending at 106, are necessary. This is the case if not all workflows in the hierarchy have been selected, yet. If there are workflows that have not been selected yet, and for which no bindings have therefore been produced, a new iteration starts at 102. If all workflows have been treated, one has calculated a set of bindings for said input workflow received at 100.

At 107, one out of the retained bindings for said input workflow is selected (for instance in order to be executed). The selection can be made through interaction via a user, communicating via an appropriate interface that allows the user for instance to inspect the range of possible tradeoffs between different QoS properties realized by different bindings.

The selection could also be made through an automatic selection that integrates some given utility function and considers all bindings that were retained for said input workflow. This is the final step of the specific embodiment.

In another embodiment, several of those steps could be omitted (e.g. the final selection could be omitted, or parts of the input is not received at every new execution of the method but retained from previous executions), new steps could be included (e.g. additional preparatory steps in which information is associated with workflows in said hierarchy that helps to decide which bindings should be discarded during filtering, including additional steps before the final selection that allow to visualize, sort, or filter retained bindings according to their QoS), the order of the steps might be varied, their execution interleaved or parallelized (e.g. the construction of bindings at 103, the QoS estimation at 104, and the filtering of bindings at 105 could be interleaved such that for a given workflow only one binding is constructed, its QoS estimated, and a decision is made whether to discard this binding or whether to keep it), and different QoS properties or precision measures can be considered that motivate different filtering methods.

In the following one will describe a specific precision measure with associated appropriate filtering methods. Note again, that this description is meant as illustrative example and does not restrict the scope of our claims.

In order to compare the QoS of different bindings in QDWSS, QoS values for a specific QoS property are usually scaled to real numbers between 0 and 1 such that 1 represents the best possible value and 0 the worst possible value. The best and worst possible value are either defined by theoretical minimum and maximum values for QoS properties with bounded value domain (e.g. for reliability which is a probability of successful execution, the theoretical minimum is 0 while the theoretical maximum is 1.0), or defined by comparison with all other bindings (e.g. response time is a priori not bounded, but a maximum bound can be established by estimating the workflow execution time when selecting the slowest possible service for every task within the workflow). For negative QoS properties, where a lower absolute values correspond to better QoS (e.g. response time) the scaled QoS value can be calculated by the following formula (one denotes by sv said scaled value, by v said absolute value for the QoS property, by LB the lower bound for this QoS property, and by UB the upper bound for this QoS property):

$$sv = \frac{min ( v , UB ) - min ( v , LB )}{( UB - LB )}$$

For positive QoS properties, where a higher absolute value corresponds to better QoS (e.g. reliability) the scaled QoS value can be calculated according to the following formula (using the same notations as before):

$$sv = \frac{max ( v , UB ) - max ( v , LB )}{( UB - LB )}$$

Based on this scaling model, one defines precision in the following over a resolution. The higher the absolute value of the resolution, the lower is the precision. This is intuitive, since a lower resolution makes details visible that are hidden with a more coarse-grained (therefore higher) resolution. One uses said resolution to map the scaled real QoS values between 0 and 1 to positive integer numbers within an interval that is determined by the resolution. One defines the QoS level for negative QoS properties by the following formula (denoting by r the resolution, by ql the QoS level, by v the absolute QoS value, by LB the lower and by UB the upper bound as before):

$$ql = ⌊ \frac{min ( v , UB ) - min ( v , LB )}{( UB - LB ) \cdot r} ⌋ \qquad ( 1 )$$

One defines the QoS level for positive QoS properties by the following formula (using the same notations as before):

$$ql = ⌊ \frac{max ( v , UB ) - max ( v , LB )}{( UB - LB ) \cdot r} ⌋ \qquad ( 2 )$$

The precision requirements at step 100 can now be defined by specifying said resolution and with the following semantic. The precision requirements specified by a given resolution r are met if for every binding A that is possible for the given input workflow and the given set of available services, the method returns at least one bindings B (which might be identical to A) such that the QoS of B are better or at least sufficiently close to the ones from A. More formally, it is required for every QoS property that the QoS level of B in this property is not lower by more than 1 than the QoS level of A in this property (QoS levels are always calculated with regards to said resolution r).

One outlines in the following a filtering method that guarantees to produce bindings that meet those precision requirements. Having selected a workflow in the hierarchy, one must decide (this refers to step 105 in the example embodiment described before) which bindings can be filtered out in order to increase efficiency while still being able to construct a set of bindings for the input workflow that satisfies the precision requirements. The filtering method outlined in the following requires two preparatory steps:
a) for every workflow in said hierarchy, a total range of possible values is calculated for each QoS property over all possible bindings. Note that this does not require to explicitly construct all possible bindings which would create significant overhead;
b) for every workflow in said hierarchy, a critical range within the range of possible values is calculated for each QoS property. The critical range marks for every workflow the range of values within a difference between two bindings can lead to different QoS of the input workflow.

One illustrates the semantic of critical ranges by an example. Assume the input workflow corresponds to a parallel execution of two tasks A and B, wherein task A requires between 10 and 20 seconds (depending on the selected binding) while task B requires between 5 and 12 seconds. Then the range between 5 and 10 seconds is non-critical for response time QoS and task B because an improvement from 10 to anything lower than 10 seconds cannot improve the overall workflow QoS. The range between 10 and 12 seconds is critical since two bindings that differ within this range could allow to construct bindings for the input workflow with different QoS. The critical range is calculated in a top-down traversal in the hierarchical decomposition of the input workflow, using the total ranges that were calculated before. One provides formulas for calculating critical ranges for standard attributes used in QDWSS and many other application domains.

Our formulas differ depending on the QoS property for which critical ranges are calculated. One classifies QoS properties into 4 classes according to their value domain (distinguishing the cases of the value domain between 0 and 1, between 0 and a constant, and unbounded) and to the aggregation functions that can be used to calculate the QoS of a sequential, parallel, or conditional execution of several tasks out of the QoS of the task. Reliability for instance is a probability and therefore its value domain is between 0 and 1. Table 4 showed our classification with several examples. For illustrative purposes, one shows why reliability is classified as it is. The reliability of a sequential or parallel execution of tasks can be calculated as product between the reliabilities of those tasks (assuming independence). The reliability of a conditional execution of tasks is in the worst case equal to the reliability of the least reliable of those tasks. This is a subset of the functions allowed for QoS properties of type 1 and since the value domain matches as well, one classifies reliability into class 1.

One describes the formulas that are used to calculate critical ranges for QoS properties of a specific type. For QoS properties of class 1, one always sets the critical range to the interval [0,1]. For QoS properties of class 2, one always sets the critical range to the interval [0,c] which corresponds to the total range of possible values. For QoS properties of type 3 and 4, one sets the critical range of the input workflow to the total QoS range that was calculated in previous steps. Starting from the input workflow, which is the root element in the decomposition hierarchy, one calculates critical ranges for the child workflows out of the critical ranges of the parent and the total ranges of the child workflows.

Let CL, CU lower and upper bound of the critical range of the parent, and TL, TU lower and upper bound of the total range of the child workflow. Assume one calculates critical ranges for a QoS attribute of type 3. The lower bound of the critical range is set to TL for QoS properties of type 3. If the QoS of the parent workflow can be calculated as minimum of the QoS of the child workflows, the upper bound of the critical range is equal to the minimum between TU and CU. If the QoS of the parent workflow can be calculated as weighted sum of the QoS of the child workflows, the upper bound is equal to the minimum of TU and TL+(CU-CL)/W where W is the weight for the QoS property of that specific child workflow when calculating the QoS for the parent as weighted sum.

Assume one calculates critical ranges for a QoS property of type 4. The upper bound of the critical range is set to TU for QoS properties of type 4. If the QoS of the parent workflow can be calculated as maximum of the QoS of the child workflows, the lower bound of the critical range is equal to the maximum between TL and CL. If the QoS of the parent workflow can be calculated as weighted sum of the QoS of the child workflows, the lower bound is equal to the maximum of TL and TU-(CU-CL)/W where W is the weight for the QoS property of that specific child workflow when calculating the QoS for the parent as weighted sum.

Critical ranges are used during filtering as follows. During filtering, one compares the bindings for a given workflow pair-wise. Comparing two bindings A and B, one uses the lower and upper bounds of the critical ranges (instead of lower and upper bound of the total QoS range) in equations (1) and (2) for calculating QoS levels for all QoS properties for the two bindings. If the QoS levels of binding A are higher or equivalent to the ones of binding B for every QoS property, one can discard binding B while having only bounded precision loss (meaning: there might be bindings for the input workflow that one cannot construct anymore due to having discarded binding B but one can construct at least a binding with similar QoS using binding A instead). Note that in order to construct a binding for the input workflow, several filtering operations are executed. The precision loss may accumulate over several filtering operations. In order to guarantee that the final precision requirements are met, one must therefore take into account how many filtering operations will be performed in total. This can be derived from the number of elements in the hierarchical decomposition of the input workflow. Having determined the number of filter operations, QoS levels during filtering have to be calculated according to a finer resolution than the target resolution, During filtering, one has to work with a resolution

$${r}_{2} = \frac{r}{N}$$

where N is the number of filter operations to execute. Doing so will guarantee that the final precision requirements are met.

Architectural paradigms such as SOAs support the evolution of software products towards modular, dynamic, and distributed structures. In this context, QoS-optimal selection of services becomes a core problem which has received significant attention in the software engineering community over the last decade. Due to the large number of possibilities, efficient and near-optimal algorithms are required to support humans in making the best selection.

Considering different QoS properties makes service selection a multi-objective optimization problem. Most approaches let users select the desired service combination indirectly by specifying a utility function on the workflow QoS. One believes that it is often more suitable, to show a representative set of near Pareto-optimal selections to the users and let them choose directly. Such algorithms can be used for instance in advanced software composition tools.

Several algorithms for this problem variant have been disclosed herein.

The first algorithm calculates all Pareto-optimal selections but has exponential time complexity. The second algorithm has polynomial time complexity but cannot make any guarantees on the precision by which the real Pareto set is approximated. Certain exemplary embodiments, however, involve a third algorithm which guarantees to meet a user-specified precision and has polynomial time complexity in all problem parameters at the same time. All algorithms support a rich workflow model including constructs such as sequence, parallel execution, and choice as well as various QoS properties.

Certain exemplary embodiments of the present invention provides a system and/or method for multi-objective service selection that combines precision guarantees with polynomial run time. It has been shown in the experimental evaluation, that calculating all Pareto-optimal selections does not scale even to medium-size problem instances. The formal analysis supports this claim by showing that no polynomial time algorithm can be expected to do so. On the other side, it has been shown that the precision of heuristic approaches drops quickly as problem instances become larger.

The embodiments of method and device disclosed herein are for illustrative purposes only and should not be interpreted a limiting the spirit and scope of the invention. It is possible to use equivalent steps and mean to achieve the same result. Also, alternative steps and means may be envisaged by a person skilled in the art of the present invention.

For example, the method may be implemented on a single computer or on a network of computers that may be accessed online or via any distance access, via wire or wirelessly, via optical means or other suitable equivalent means.

The input device 2 may be any suitable means: keyboard, ports (such as USB ports) or a dedicated program generating the suitable input parameters.

The computer device 2 may by a single device (such as a PC) or a network of devices.

The readable medium 4 may be a hardware device (such as a disk, a memory, a flash device) or a network such as the internet or a cloud.

The output device 3 may be any suitable and desired means such as a screen, ports (such as USB ports), a printer or a network.

The steps of the method may be carried out in serial or in parallel order, or in a combination of serial and parallel steps. The steps are also not necessarily executed in the given order or be separate steps but they could be interleaved (e.g. one might execute step d) first and generate a complete set of assignments, and then execute step f) to filter this set of assignments; or: one executes step d) to generate one assignment and then step f) to possibly filter this assignment, then step d) again to generate another assignment and f) to filter it, then again step d) etc. always for the same node. Accordingly, several steps may also be repeated several times as well.

Also it is not limited to two nodes (parent and child) but more levels and nodes may be present and a parent node may have more than one child node.

The techniques described herein may be used in different fields, such as for example construction work, computer programs, general workflows, finance (investments) where multiple parameters are to be taken into consideration in workflows and optimization is sought in application of the teachings of the disclosure.

### REFERENCES

### All Incorporated by Reference in the Present Application

[1] L. Baresi, E. Di Nitta, and C. Ghezzi, “Toward Open-World Software: Issue and Challenges,” IEEE Computer, vol. 39, no. 10, pp. 36-43,2006.
[2] M. Papazoglou and W. Van Den Heuvel, “Service-Oriented Architectures: Approaches, Technologies and Research Issues,” VLDB journal, vol. 16, no. 3, pp. 389-415, 2007.
[3] T. Andrews, H. Dholakia, Y. Goland, B. Klein, K. Liu, S. Roller, D. Smith, S. Thatte, I. Trickovic, and S. Weerawarana, “Business Process Execution Language for Web Services,” 2003.
[4] J. Morse, Human Choice Theory: Implications for Multicriteria Optimization, 1976.
[5] D. Claro, P. Albers, and J. Hao, “Selecting Web Services for Optimal Composition,” in IEEE ICWS International Workshop on Semantic and Dynamic Web Processes, 2005, pp. 32-45.
[6] Q. Yu and A. Bouguettaya, “Computing Service Skylines over Sets of Services,” in IEEE Int. Conf. on Web Services, 2010, pp. 481-488.
[7] D. Hochba, “Approximation Algorithms for NP-hard Problems,” ACM SIGACT News, vol. 28, no. 2, pp. 40-52, 1997.
[8] L. Zeng, B. Benatallah, A. Ngu, M. Dumas, J. Kalagnanam, and H. Chang, “QoS-Aware Middleware for Web Services Composition,” IEEE Trans. on Software Engineering, vol. 30, no. 5, pp. 311-327, 2004.
[9] D. Ardagna and B. Pernici, “Adaptive Service Composition in Flexible Processes,” IEEE Trans. on Software Engineering, pp. 369-384, 2007.
[10] D. Comes, H. Baraki, R. Reichle, M. Zapf, and K. Geihs, “Heuristic Approaches for QoS-Based Service Selection,” in Int. Conf. on Service-Oriented Computing. Springer, 2010, pp. 441-455.
[11] K. Deb, A. Pratap, S. Agarwal, and T. Meyarivan, “A Fast and Elitist Multiobjective Genetic Algorithm: NSGA-II,” IEEE Trans. on Evolutionary Computation, vol. 6, no. 2, pp. 182-197, 2002.
[12] E. Al-Masri and Q. Mahmoud, “Discovering the Best Web Service,” in ACM Int. World Wide Web Conf., 2007, pp. 1257-1258.
[13] R. Aggarwal, K. Verma, J. Miller, and W. Milnor, “Constraint Driven Web Service Composition in Meteor-S,” in IEEE Int. Conf. on Services Computing, 2004, pp. 23-30.
[14] A. Hassine, S. Matsubara, and T. Ishida, “A Constraint-Based Approach to Horizontal Web Service Composition,” Int. Semantic Web Conf., vol. 4273, no. 38, pp. 130-143, 2006.
[15] G. Canfora, M. Di Penta, R. Esposito, and M. Villani, “An Approach for QoS-Aware Service Composition Based on Genetic Algorithms,” in ACM Conf. on Genetic and Evolutionary Computation, 2005, pp. 1069-1075.
[16] Y. Gao, B. Zhang, J. Na, L. Yang, Y. Dai, and Q. Gong, “Optimal Selection of Web Services for Composition Based on Interface-Matching and Weighted Multistage Graph,” in IEEE Int. Conf. on Parallel and Distributed Computing, Applications and Technologies, 2005, pp. 336-338.
[17] C. Gao, M. Cai, and H. Chen, “QoS-Aware Service Composition Based on Tree-Coded Genetic Algorithm,” in IEEE Int. Computer Software and Applications Conf., vol. 1, 2007, pp. 361-367.
[18] L. Ai and M. Tang, “A Penalty-Based Genetic Algorithm for QoS-Aware Web Service Composition with Inter-Service Dependencies and Conflicts,” in IEEE Int. Conf. on Computational Intelligence for Modelling Control and Automation, 2008, pp. 738-743.
[19] M. Tang and L. Ai, “A Hybrid Genetic Algorithm for the Optimal Constrained Web Service Selection Problem in Web Service Composition,” in IEEE Congress on Evolutionary Computation, 2010, pp. 1-8.
[20] M. Jaeger, G. Muhl, and S. Golze, “QoS-Aware Composition of Web Services:

An Evaluation of Selection Algorithms,” On the Move to Meaningful Internet Systems 2005: CoopIS, DOA, and ODBASE, pp. 646-661, 2005.
[21] T. Yu and K. Lin, “Service Selection Algorithms for Composing Complex Services with Multiple QoS Constraints,” in Int. Conf. on Service-Oriented Computing. Springer, 2005, pp. 130-143.
[22] T. Yu, Y. Zhang, and K. Lin, “Efficient Algorithms for Web Services Selection with End-to-End QoS Constraints,” ACM Trans. on the Web, vol. 1, no. 1, 2007.
[23] R. Berbner, M. Spahn, N. Repp, O. Heckmann, and R. Steinmetz, “Heuristics for QoS-Aware Web Service Composition,” in IEEE Int. Conf. on Web Services, 2006, pp. 72-82.
[24] P. Bonatti and P. Festa, “On Optimal Service Selection,” in ACM Int. World Wide Web Conf., 2005, pp. 530-538.
[25] A. Klein, F. Ishikawa, and S. Honiden, “Efficient QoS-Aware Service Composition with a Probabilistic Service Selection Policy,” in Int. Conf. on Service-Oriented Computing. Springer, 2010, pp. 182-196.
[26] H. Wada, P. Champrasert, J. Suzuki, and K. Oba, “Multiobjective Optimization of SLA-Aware Service Composition,” in IEEE Congress on Services, 2008, pp. 368-375.
[27] C. Jiuxin, S. Xuesheng, Z. Xiao, L. Bo, and M. Bo, “Efficient Multi-Objective Services Selection Algorithm Based on Particle Swarm Optimization,” in IEEE Asia-Pacific Conf. on Services Computing, 2010, pp. 603-608.
[28] G. Kousalya, D. Palanikkumar, and P. Piriyankaa, “Optimal Web Service Selection and Composition Using Multi-Objective Bees Algorithm,” in IEEE Int. Symposium on Parallel and Distributed Processing with Applications Workshops, 2011, pp. 193-196.
[29] Q. Yu and A. Bouguettaya, “Efficient Service Skyline Computation for Composite Service Selection,” IEEE Trans. on Knowledge and Data Engineering, no. 99, 2011, Early Access Article.
[30], ______ “Computing Service Skyline from Uncertain QOWS,” IEEE Trans. on Services Computing, vol. 3, no. 1, pp. 16-29, 2010

### APPENDIX

### A. Proof of Theorem 8

The following notations are used for this Appendix. Let W a complex workflow, nested fragment of a workflow [symbol] , W₁ and W₂ the fragments of W (<W₁,W₂>=Split(W)), b₁ and b₂ two bindings for W, and r a resolution. One will also refer to W as the parent (fragment) and to W₁ and W₂ as the child fragments. One assumes that critical ranges for all nested fragments of [symbol] have been calculated, in particular for W, W₁, and W₂. One denotes the critical range of workflow W by CR(X) for X∈{W,W₁,W₂}. One implicitly assume for this Appendix that the QoS level for a workflow is always calculated with respect to its critical range and resolution r. Short notations are introduced: q[X]ᵢ^{a}=QoS^{a}(X,bᵢ) and ql[X]ᵢ^{a}=QoSlevel^{a}(X,bᵢ,CR(X),r) for i∈{1,2} and X∈{W,W₁,W₂}.

Lemmata 4 and 5 show that if the QoS in change outside the critical range, this does not influence the QoS level in W. Lemma 4 is illustrated by FIG. 21.

### Lemma 4.

If ∀i∈{1,2}:q[W₁]ᵢ^{a}<CR_{L}¹(W₁) and q[W₂]₁^{a}=q[W₂]₂^{a} for attribute a∈ [symbol] ,then ql[W]₁^{a}=ql[W]₂^{a}.

Proof: Note that the lower bounds of critical range and total QoS range coincide for all attributes of type 1, 2, and 3. Therefore, a[W₁]ᵢ^{a}<CRₗ^{a}(W₁) for i∈{1,2} is only possible if a is of type 4. If a is of type 4, only the aggregation functions sum and maximum are allowed (see Table 3, Section 3), Assume sum aggregation: q[W]ᵢ^{a}=w₁·q[W₁]ᵢ^{a}+w₂·q[W₂]ᵢ^{a}. Then q[W₁]ᵢ^{a}<CR_{L}^{a}(W₁) implies q[W]ᵢ^{a}<CR_{L}^{a}(W), independently of the value of q[W₂]ᵢ^{a}. All QoS values lower than the lower bound of the critical range are mapped to the same QoS level (either the highest or the lowest possible level). Therefore ql[W]₁^{a}=ql[W]₂^{a}. Assume maximum aggregation: q[W]ᵢ^{a}=max□(q[W₁]ᵢ^{a},q[W₂]ᵢ^{a}). q[W₁]ᵢ^{a}<CR_{L}^{a}(W₁) implies that either q[W]ᵢ^{a}=q[W₂]ᵢ^{a} or q[W]ᵢ^{a}≦CRᵢ^{a} and therefore ql[W]₁^{a}=ql[W]₂^{a} since b₁ and b₂ have same QoS in W₂.

### Lemma 5.

If ∀i∈{1,2}:q[W₁]ᵢ^{a}>CR_{U}^{a}(W₁) and q[W₂]₁^{a}=q[W₂]₂^{a} for attribute a∈ [symbol] ,then ql[W]₁¹=ql[W]₂^{a}.

Proof: Note that the upper bounds of critical range and total QoS range coincide for all attributes of type 1, 2, and 4. It is only needed to prove the theorem for attributes of type 3. The proof is an analogue to the one of Lemma 4.

Lemmata 6 and 7 show that the absolute value of the QoS change in the parent is bounded by the change in the child. Lemma 6 is illustrated in FIG. 22.

### Lemma 6.

For all attributes a∈ [symbol] that are aggregated as minimum, maximum, or product in W, one has

$$\vert {q [ W ]}_{2}^{a} - {q [ W ]}_{1}^{a} \vert \leq {\sum }_{i = 1}^{2} \vert {q [ {W}_{i} ]}_{2}^{a} - {q [ {W}_{i} ]}_{1}^{a} \vert .$$

Proof: The lemma holds for the cases q[W]ᵢ^{a}=max□(q[W₁]ᵢ^{a}, q[W₂]ᵢ^{a}) and q[W]ᵢ^{a}=min□(q[W₁]ᵢ^{a},q[W₂]ᵢ^{a}) due to the general properties of maximum and minimum function. Consider the case q[W]ᵢ^{a}=q[W₁]ᵢ^{a}·q[W₂]ᵢ^{a}. The product aggregation is only allowed for attributes of type 1 (see Table 4). For those attributes, the value domains are restricted to the domain [0,1]. Because of that, the lemma holds also in this case.

### Lemma 7.

For all attributes a E A that are aggregated as weighted sum in W,

$${q [ W ]}_{i}^{a} = {\sum }_{j = 1}^{2} {qw}_{j} \cdot {q [ {W}_{j} ]}_{i}^{a} for i ∈ \{ 1 , 2 \} ,$$

one has

$$\vert {q [ W ]}_{2}^{a} - {q [ W ]}_{1}^{a} \vert \leq {\sum }_{j = 1}^{2} {qw}_{j} \cdot \vert {q [ {W}_{j} ]}_{2}^{a} - {q [ {W}_{j} ]}_{1}^{a} \vert .$$

Proof: The lemma trivially follows from the properties of the sum function.

Lemmata 8 and 9 show that the width of the critical range in the child is bounded in function of the width in the parent.

### Lemma 8.

For all attributes a∈ [symbol] that are aggregated as maximum, minimum, or product in W, one has CR_{U}^{a}(W)−CR_{L}^{a}(W)≧CR_{U}^{a}(Wᵢ)−CR_{L}^{a}(Wᵢ) for i∈{1,2}.

Proof: The lemma is trivial for attributes of type 1 and 2 since the critical range always corresponds to the total QoS range which is constant for attributes of those types. If a is aggregated as product, the attribute must be of type 1. Assume now that a is of type 3. Then the lower bound of the critical range always coincides with the lower bound of the total QoS range. If a is aggregated as minimum in W, one has CR_{L}^{a}(W)≦CR_{L}^{a}(Wᵢ) for i∈{1,2}, One also has CR_{U}^{a}(Wᵢ)=min□(QR_{U}^{a}(Wᵢ),CR_{U}^{a}(W)) according to the formulas from Table 3. Therefore, it is CR_{U}^{a}(Wᵢ)≦CR_{U}^{a}(W). The proof for attributes of type 4 and maximum aggregation is analogue.

### Lemma 9.

For all attributes a∈ [symbol] that are aggregated as weighted sum in W,

$${q [ W ]}_{i}^{a} = {\sum }_{j = 1}^{2} {qw}_{j} \cdot {q [ {W}_{j} ]}_{i}^{a} ,$$

one has for i∈{1,2}.

$${CR}_{U}^{a} ( W ) - {CR}_{L}^{a} ( W ) \geq \frac{{CR}_{U}^{a} ( {W}_{i} ) - {CR}_{L}^{a} ( {W}_{i} )}{{qw}_{i}}$$

Proof: The lemma is trivial for attributes of type 1 and 2 since the critical range always corresponds to the total QoS range which is constant for attributes of those types. Assume a is of type 3. Then the lower bound of the critical range always coincides with the lower bound of the total QoS range. Attribute a is aggregated as weighted sum in W, therefore

$${CR}_{U}^{a} ( {W}_{i} ) - {CR}_{L}^{a} ( {W}_{i} ) \leq \frac{{CR}_{U}^{a} ( W ) - {CR}_{L}^{a} ( W )}{{qw}_{i}}$$

for i∈{1,2} as direct implication of the formulas in Table 3. The proof for attributes of type 4 is analogue.

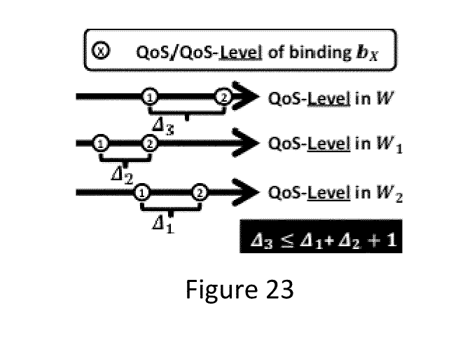

The following theorem shows that the QoS level difference in the parent can be bounded by the QoS level differences in the two child fragments. The theorem is illustrated in FIG. 23.

### Theorem 11.

It is

$$\vert {ql [ W ]}_{1}^{a} - {ql [ W ]}_{2}^{a} \vert \leq 1 + {\sum }_{i = 1}^{2} \vert {ql [ {W}_{i} ]}_{1}^{a} - {ql [ {W}_{i} ]}_{2}^{a} \vert$$

for all attributes a∈ [symbol] .

Proof: According to Lemmata 4 and 5, one can assume without restriction of generality that for i,j,∈{1,2} the QoS of binding bⱼ in is within the corresponding critical range: CR_{L}^{a}(Wᵢ)≦q[Wᵢ]ⱼ^{a}≦CR_{U}^{a}(Wᵢ). if a is aggregated as maximum, minimum, or product in W, the QoS difference between b₁ and b₂ in W is bounded by the sum of the QoS differences in W₁ and W₂, according to Lemma 6. Since the critical range in W has at least the same width as the one in W₁ or W₂, according to Lemma 8, the same absolute QoS difference means in W₁ or W₂ a higher difference in QoS levels than in W (due to shifting, one may have one QoS level more in W). Therefore,

$$\vert {ql [ W ]}_{2}^{a} - {ql [ W ]}_{1}^{a} \vert \leq 1 + {\sum }_{i = 1}^{2} \vert {ql [ {W}_{i} ]}_{1}^{a} - {ql [ {W}_{i} ]}_{2}^{a} \vert .$$

If a is aggregated as weighted sum in W,

$${q [ W ]}_{i}^{a} = {\sum }_{j = 1}^{2} {qw}_{j} \cdot {q [ {W}_{j} ]}_{i}^{a} ,$$

then

$$\vert {q [ W ]}_{2}^{a} - {q [ W ]}_{1}^{a} \vert \leq {\sum }_{j = 1}^{2} {qw}_{j} \cdot \vert {q [ {W}_{j} ]}_{2}^{a} - {q [ {W}_{j} ]}_{1}^{a} \vert$$

according to Lemma 7. On the other side,

$${CR}_{U}^{a} ( W ) - {CR}_{L}^{a} ( W ) \geq \frac{{CR}_{U}^{a} ( {W}_{i} ) - {CR}_{L}^{a} ( {W}_{i} )}{{qw}_{i}}$$

according to Lemma 9. So the critical range of TV for a might be smaller than the one from W₁ or W₂ and the same difference in absolute QoS would translate into a higher difference in QoS levels in W than in W₁ or W₂. However, since (i∈{1,2}) the critical range in Wᵢ is broader at most by factor

$$\frac{1}{{qw}_{i}}$$

and the QoS difference in Wᵢ translates into a QoS difference in W that is scaled by factor qwᵢ, Theorem 11 holds again.

One can finally use Theorem 11 to prove Theorem 8.

### Theorem 8.

Let W a complex workflow, <W₁,W₂>=Split(W). Denote by Bᵢ results of the calls PQDSSrec<3(Wᵢ,r) for i∈{1,2} and by B the result of the call PQDSSrec<3>(W,r). Then ∀i∈{1,2}:Psetₑ_{ᵢ}(Bᵢ,Wᵢ,CR(Wᵢ),r) implies Psetₑ_{₁}₊ₑ_{₂}₊₁(B,W,CR(W),r).

Proof: For any binding b on the Pareto-frontier for W, one can find a Pareto-optimal binding for b₁ for W₁ and a Pareto-optimal binding b₂ for W₂ such that QoS(W,b)=QoS(W,b₁∪b₂) (see Lemma 1). Since Psetₑ_{₁}(B₁,W₁,CR(W₁),r)=E₁, one finds a binding \tilde{b}₁∈B₁ such that ∀a∈ [symbol] :(QoSlevel(W₁,b₁,CR(W₁),r)−QoSlevel^{a}(W₁,\tilde{b}₁,CR(W₁),r))≦eᵢ. For the same reasons, one finds a binding \tilde{b}₂∈B₂ such that ∀a∈ [symbol] :(QoSlevel^{a}(W₂,b₂,CR(W₂),r)−QoSlevel^{a}(W₂,\tilde{b}₂,CR(W₂),r))≦e₂. Those bindings (\tilde{b}₁ and \tilde{b}₂) can be combined into a binding \tilde{b}=\tilde{b}₁∪\tilde{b}₂ for W.

According to Theorem 11, one has ∀a∈ [symbol] :(QoSlevel(W,b,CR(W)r)−QoSlevel(C,b,CR^{a}(W),r))≦e₁+e₂+1. Therefore, the call PQDSSrec<3>(W,r) will return \tilde{b} or a binding with equivalent QoS levels. This implies Theorem 8.

B. Proof that A-FPTAS Cannot Use Target Resolution Directly

A-FPTAS chooses the internal resolution finer than the target resolution by a factor proportional to the number of workflow fragments. The following theorem shows that there are actually worst-cases where the Pareto error is proportional to the number of fragments for a fixed resolution. This proves the necessity of choosing the internal resolution finer than the target resolution.

### Theorem 12.

For every N, there is a workflow W with N fragments such that the call PQDSSrec<3>(W) returns a set B such that for

$$tr = \frac{1}{N}$$

the Pareto error of B is at least N−1, e.g. [symbol] e<N−1:Psetₑ(W,B,tr).

Proof: By ∈ one denotes an infinitesimally small quantity, one sets ρ=1−∈. One constructs a workflow W with N nested fragments. The workflow has only one simple task, one denotes this fragment by f_{N} and the others by f₁, . . . , f_{N-1} such that f₁ designates the entire workflow W. One requires ∀1≦i<N:<fᵢ₊₁,∈>=Split(fᵢ) (∈designates the empty task). One assumes that there are N+1 positive QoS attributes of type 1 (see Table 4) so their value domain is the interval R=[0,1] which corresponds at the same time to their critical ranges for all fragments. One numbers those attributes a₁ to a_{N+1}. There are N+1 services available for f_{N}, allowing N+1 bindings b₀ to b_{N}. One describes the QoS of the i-th binding:

$${QoS}^{{a}_{N + 1}} ( W , {b}_{i} ) = {ρ}^{- N + i + 1} \cdot \frac{i}{N} , {QoS}^{{a}_{i}} ( W , {b}_{i} ) = \frac{{ρ}^{2 - N + i}}{N} ,$$

and 1≦j≦N, i≠j:Qos^{a}^{ᵢ}(W,bᵢ)=0. The QoS of all attributes is aggregated in all fragments by multiplication by ρ (this is a special case of the weighted sum). One instance of the function PQDSSrec<3> will be invoked for every fragment fᵢ and possibly filter out bindings. Treating fᵢ for 1≦i≦N, it is QoS(fᵢ,bᵢ₋₁)=_{R,tr} QoS(fᵢ,bᵢ) and one assumes that bᵢ is filtered out while bᵢ₋₁ is kept (this corresponds to the worst case). Note that when treating fᵢ all bindings bⱼ for 0≦j<i are Pareto-optimal and therefore not filtered out. The end result is that one selects binding b₀ with QoS(W,b₀)=(0, . . . , 0) and QoSlevel(W,b₀,R,tr)=0 while binding b_{N} with QoS(W,b_{N})=(1·ρ^{N},0, . . . , 0) and QoSlevel(W,b_{N},R,tr)=N−1 would have been the best choice. Therefore, the Pareto error of the result is N−1.

What is claimed is:

1. A computer-implemented method for approximating the set of Pareto-optimal bindings for a workflow comprising choice variables, wherein each binding assigns each of said variables to one value, said method comprising:
a) receiving an input workflow description comprising a set of variables, a set of alternative values for each of said variables, a function relating said variables in said workflow with cost and/or quality properties of said workflow, and a minimum precision;
b) associating with said input workflow a hierarchical decomposition comprising at least a first node and a second node wherein said first node is the parent of said second node and both nodes are associated with workflow descriptions such that all variables comprised in the workflow description associated with said second node are also comprised in the workflow description associated with said first node;
c) computing, via at least one processor, for the second node a set of bindings, each binding associating each variable of the workflow associated with said second node with a value;
d) computing, via the at least one processor, for the first node a set of bindings, each binding associating each variable of the workflow associated with said first node with a value, wherein each binding computed for said first node is constructed out of a binding computed for said second node such that said binding computed for said first node assigns all variables comprised in the workflow associated with said second node to the same values as the binding for said second node it was constructed from;
e) associating with each of the bindings computed for said first node the quality and/or cost properties according to the function received in a); and
f) filtering the set of bindings associated with the first node to possibly reduce its size, said filtering being executed such that the minimum precision requirements are respected.

2. The method of claim 1 wherein at least one of the variables contained within the description of said input workflow comprises a choice between alternative services for a task within said input workflow.

3. The method of claim 1 wherein at least one of the variables contained within the description of said input workflow comprises a choice between alternative workers for a task within said input workflow.

4. The method of claim 1 wherein at least one of the variables contained within the description of said input workflow comprises a choice between alternative workflow parts of said input workflow.

5. The method of claim 1 wherein the set of considered cost and/or quality properties comprises at least one of the following properties or a combination thereof: execution time, execution cost, energy consumption, availability, reliability, throughput, reputation, or a measure of result quality.

6. The method of claim 5, wherein the measure of result quality comprises result precision or result confidence or result resolution.

7. The method of claim 1 wherein formulas are used that express at least one of the cost and/or quality properties of the workflow associated with said first node as a function of at least one of the cost and/or quality properties of the workflow associated with said second node.

8. The method of claim 1 wherein said precision requirements for at least one of the cost and/or quality properties of said input workflow are defined using one of the following
a) a resolution referring to a space within which cost and/or quality properties of said input workflow can be represented;
b) a distance between cost and/or quality properties of bindings from variables within said input workflow to values that said method computes and cost and/or quality properties of possible bindings; and
c) a percentage or multiplicative factor being used to compare cost and/or quality properties of possible bindings from variables within said input workflow to values with bindings that said method computes.

9. The method of claim 1, further comprising associating information with said first node or said second node or both, that are used to compare cost and/or quality properties of bindings from variables within said input workflow to values.

10. The method of claim 9, wherein the associating of the additional information with said first node or said second node or both comprises:
a) computing, for each cost and/or quality property, the range of values that could be reached by bindings associated with the second node and with the first node;
b) selecting, for each cost and/or quality property, a subset of the range associated with the first node; and
c) applying said subset to the range associated with the second node, thus reducing the range associated with said second node to a critical range.

11. The method of claim 1 further comprising at least one of:
a) presenting to the user an approximated set of Pareto-optimal bindings from variables within said input workflow to values or a subset of said bindings;
b) presenting to the user information about cost and/or quality properties of an approximated set of Pareto-optimal bindings from variables within said input workflow to values or of a subset of said bindings;
c) allowing the user to make a selection between binding from variables within said input workflow to values; and
d) automatically selecting between bindings from variables within said input workflow to values.

12. The method of claim 1, wherein the steps are executed in serial order or in parallel order or interleaved or in a combination thereof.

13. The method of claim 1, wherein some steps are repeated.

14. A computer device linked to input devices, output devices, and to a readable medium carrying a program, wherein said program, when operating in connection with said computer device, causes said computer device to at least:
a) receive an input workflow description comprising a set of variables, a set of alternative values for each of said variables, a function relating said variables in said workflow with cost and/or quality properties of said workflow, and a minimum precision;
b) associate with said input workflow a hierarchical decomposition comprising at least a first node and a second node wherein said first node is the parent of said second node and both nodes are associated with workflow descriptions such that all variables comprised in the workflow description associated with said second node are also comprised in the workflow description associated with said first node;
c) compute for the second node a set of bindings, each binding associating each variable of the workflow associated with said second node with a value;
d) compute for the first node a set of bindings, each binding associating each variable of the workflow associated with said first node with a value, wherein each binding computed for said first node is constructed out of a binding computed for said second node such that said binding computed for said first node assigns all variables comprised in the workflow associated with said second node to the same values as the binding for said second node it was constructed from;
e) associate with each of the bindings computed for said first node the quality and/or cost properties according to the function received in a); and
f) filter the set of bindings associated with the first node to possibly reduce its size, said filtering being executed such that the minimum precision requirements are respected.

15. The computer device as defined in claim 14, wherein the computer device is a standalone device or a plurality of networked devices.

16. The computer device as defined in 14, wherein the readable medium is a hardware device or a network.

17. The computer device as defined in 14, wherein the program further causes the computer device to:
a) present to the user an approximated set of Pareto-optimal bindings from variables within said input workflow to values or a subset of said bindings; and/or
b) present to the user information about cost and/or quality properties of an approximated set of Pareto-optimal bindings from variables within said input workflow to values or of a subset of said bindings; and/or
c) allow the user to make a selection between binding from variables within said input workflow to values; and/or
d) automatically select between bindings from variables within said input workflow to values.

18. A non-transitory computer readable storage medium tangibly storing a program comprising instructions that, when executed by a computer system having at least one processor and a memory, cause the computer system to at least:
a) receive an input workflow description comprising a set of variables, a set of alternative values for each of said variables, a function relating said variables in said workflow with cost and/or quality properties of said workflow, and a minimum precision;
b) associate with said input workflow a hierarchical decomposition comprising at least a first node and a second node wherein said first node is the parent of said second node and both nodes are associated with workflow descriptions such that all variables comprised in the workflow description associated with said second node are also comprised in the workflow description associated with said first node;
c) compute for the second node a set of bindings, each binding associating each variable of the workflow associated with said second node with a value;
d) compute for the first node a set of bindings, each binding associating each variable of the workflow associated with said first node with a value, wherein each binding computed for said first node is constructed out of a binding computed for said second node such that said binding computed for said first node assigns all variables comprised in the workflow associated with said second node to the same values as the binding for said second node it was constructed from;
e) associate with each of the bindings computed for said first node the quality and/or cost properties according to the function received in a); and
f) filter the set of bindings associated with the first node to possibly reduce its size, said filtering being executed such that the minimum precision requirements are respected.

19. The non-transitory computer readable storage medium of claim 18, wherein the program comprises further instructions that cause the computer system to at least:
a) present to the user an approximated set of Pareto-optimal bindings from variables within said input workflow to values or a subset of said bindings; and/or
b) present to the user information about cost and/or quality properties of an approximated set of Pareto-optimal bindings from variables within said input workflow to values or of a subset of said bindings; and/or
c) allow the user to make a selection between binding from variables within said input workflow to values; and/or
d) automatically select between bindings from variables within said input workflow to values.
